(19) United States
(12) Patent Application Publication
(10) Pub. No.: US 2019/0073620 A1
(43) Pub. Date: Mar. 7, 2019

(54) SYSTEM, METHOD AND COMPUTER PROGRAM PRODUCT FOR DATA ANALYSIS

(71) Applicant: C-B4 CONTEXT BASED FORECASTING LTD, Herzelia (IL)

(72) Inventors: Roee Eli ANUAR OR, Givatayim (IL); Gonen SINGER, Kfar Saba (IL); Noam Lee Cohen, Hoboken, NJ (US)

(21) Appl. No.: 16/085,612

(22) PCT Filed: Mar. 21, 2017
(86) PCT No.: PCT/IL17/50349

§ 371 Date: Sep. 17, 2018

Related U.S. Application Data
(60) Provisional application No. 62/315,025, filed on Mar. 30, 2016.

(51) Int. Cl. G06Q 10/06; G06F 17/30; G06Q 30/02

(52) U.S. Cl. CPC G06Q 10/06315; G06F 17/30604; G06N 99/005; G06Q 10/067; G06Q 30/0202; G06F 17/30958

(57) ABSTRACT

A system for data analysis, the system comprising a processor configured to: obtain data relating to a plurality of entities associated with a plurality of distinct locations, the data including a plurality of values of one or more entity-related parameters related to each entity of the entities at each location of the locations, each value representing a corresponding time period; calculate, for a plurality of entity pairs of the entities, utilizing the values, an influence score indicative of a connection between at least one of the entity-related parameters of the entity pair at the plurality of locations; generate, utilizing the influence scores, one or more influence models, each describing influences between two or more of the entities and being usable for generating recommendations relating to at least one entity of the entities.

### TECHNICAL FIELD

The invention relates to a system, method and computer program product for data analysis, and more specifically to a system, method and computer program product for providing recommendations based on the data analysis.

### BACKGROUND

In some cases, data analysis can reveal various patterns and/or relationships between various parameters comprised within the data. Analysis of such patterns and/or relationships can provide meaningful insights relating to behaviors of various entities. The entities can be systems (including computerized systems), users of such systems, customers of various businesses (e.g. retail businesses, wholesale businesses, financial institutions, governmental institutions, etc.), etc. There is thus a need in the art for a new system, method and computer program product for data analysis, enabling revealing such hidden patterns, hidden within the data, and providing insights and/or recommendations to users (human and/or computerized) of the system.

### GENERAL DESCRIPTION

In accordance with a first aspect of the presently disclosed subject matter, there is provided a system for data analysis, the system comprising a processor configured to: obtain data relating to a plurality of entities associated with a plurality of distinct locations, the data including a plurality of values of one or more entity-related parameters related to each entity of the entities at each location of the locations, each value representing a corresponding time period; calculate, for a plurality of entity pairs of the entities, utilizing the values, an influence score indicative of a connection between at least one of the entity-related parameters of the entity pair at the plurality of locations; and generate, utilizing the influence scores, one or more influence models, each describing influences between two or more of the entities and being usable for generating recommendations relating to at least one entity of the entities, wherein the influences are single-sided so that for each given entity of the entities and any other entity of the entities that is directly or indirectly influenced by the given entity according to the corresponding model, the given entity is not influenced by the other entity according to the corresponding influence model.

In some cases, each of the influence models is a simple weighted directed graph comprising a plurality of nodes, wherein each node of the nodes is associated with a distinct entity of the entities and each connection connecting a pair of the nodes is associated with a weight, the weight being associated with the influence score of the corresponding entities.

In some cases, the influence models are generated such that for each influence model of the influence models, a function of the weights associated with the influence model's connections exceeds a threshold.

In some cases, the function of the weights is a sum of the weights.

In some cases, the weight is the influence score.

In some cases, the entities are products and the entity-related parameters are product-related parameters including at least one of the following:
a. a number of sold amounts of the product;
b. a revenue generated from sale of the number of sold amounts of the product;
c. a profit generated from sale of the number of sold amounts of the product;
d. a number of stored amounts of the product;
e. a number of ordered amounts of the product;
f. a cost of purchase of the number of sold amounts of the product;
g. a forecasted sales amount;
h. a forecasted revenue from the forecasted sales amount;
i. a forecasted profit from the forecasted sales amount;
j. a forecasted number of stored amounts of the product;
k. a forecasted number of ordered amounts of the product; or
l. an interest indicative parameter.

In some cases, the processor is further configured to utilize one or more additional parameter of the following additional parameters for generating the one or more influence models:
a. promotions relating to the product;
b. customer-related properties of the sold amount of the product;
c. customer-related properties of the ordered amount of the product;
d. shelf-related properties of the product;
e. customer grading of the product;
f. pricing information of the product;
g. packaging of the product;
h. recommendation implementation information, relating to the product at the location, received from a user at the location;
i. assortment of the product in the location;
j. training of staff at the location;
k. planogram of the location;
l. staff-related properties of the location.

In some cases, the entities are products and the processor is further configured to provide a recommendation relating to a selected product of the products, at a given location of the locations, utilizing the influence model.

In some cases, the recommendation is to introduce the selected product to the given location, the given location belonging to a group of two or more selected locations of the locations, wherein the selected product is not located at the given location and wherein introducing the selected product to the given location is expected to yield a high sales level of the selected product at the given location relative to locations that are not included in the group, wherein the group is determined utilizing the influence model.

In some cases, the recommendation is to check behavior of the selected product at the given location, the given location belonging to a group of two or more selected locations of the locations, wherein the selected product is located at the given location according to the data and wherein the given product at the given location is expected to, but does not, yield a high sales level relative to locations not included in the group, wherein the group is determined utilizing the influence model.

In some cases, the recommendation is to check behavior of the selected product at the given location, the given location belonging to a group of two or more selected locations of the locations, wherein the selected product is located at the given location according to the data and wherein the given product at the given location is expected to, but does not, yield a low sales level relative to locations not included in the group, wherein the group is determined utilizing the influence model.

In some cases, the recommendation is to remove the selected product from the given location, wherein the selected product is located at the given location according to the data and wherein a sales-related parameter of the product-related parameters of the selected product at the given location is lower than a minimal expected sales-related parameter calculated utilizing sales-related parameters of the selected product at a group of two or more selected locations of the locations, wherein the group is determined utilizing the influence model.

In some cases, the recommendation is to move the selected product, located at the given location, the given location belonging to a group of two or more selected locations of the locations, to a certain vicinity to a second product of the products located at the given location, wherein the selected product and the second product are located at the given location according to the data and wherein a combined sales level of the selected product and the second product is expected to be higher than a combined sales level of the selected product and the second product at locations that are not included in the group, wherein the group is determined utilizing (a) the influence model and (b) a products map of the products within the corresponding locations.

In some cases, the recommendation is to introduce the selected product to the given location, the given location belonging to a group of two or more selected locations of the locations, wherein the selected product is not located at the given location and wherein introducing the selected product to the given location is expected to yield a high sales level of at least one other product at the given location relative to locations that are not included in the group, wherein the group is determined utilizing the influence model.

In some cases, the group is determined so that for at least one other product, other than the selected product, the product-related parameter is within a boundary in each location of the group.

In some cases, the boundary is defined by a low threshold and a high threshold.

In some cases, the boundary is pre-determined.

In some cases, the boundary is dynamically calculated.

In some cases, the recommendation is to remove the selected product from the given location, wherein the selected product is located at the given location according to the data and wherein removing the selected product from the given location is expected to result in an increase of the sales of at least one second product at the given location wherein the increase of the sales of the second product results in increased profits at the given location.

In some cases, the recommendation is to change a pricing or a placement or a packaging or a number of stored amounts of the selected product, or to perform a promotion of the selected product, in the given location of the locations, wherein the selected product is located at the given location according to the data and wherein acting upon the recommendation is expected to increase profits at the at the given location.

In some cases, the processor is further configured to monitor implementation of the recommendation.

In some cases, the entities are products and wherein each product of the products is associated with a corresponding product time window usable for determining the plurality of values of the product-related parameters related to the product to be used for calculating the influence scores.

In some cases, the product time window is a number of consecutive time windows, so that a percentage of units of the product sold during the consecutive time windows, out of a number of sold units of the product, is higher than a sales percentage threshold, and wherein the number of sold units is one of the entity-related parameters.

In some cases, the product time window is associated with a high threshold and wherein if the number of consecutive time windows is above the threshold, the time period is set according to the threshold.

In some cases, the product time window is a most frequent number of consecutive time periods out of numbers of consecutive time periods calculated for each product, so that a percentage of units of the corresponding product sold during the consecutive time periods, out of a number of sold units of the corresponding product, is higher than a sales percentage threshold, and wherein the number of sold units is one of the entity-related parameters.

In some cases, the product time window is associated with a high threshold and wherein if the most frequent number of consecutive time windows is above the threshold, the product time window is set according to the threshold.

In some cases, each product is associated with a product category and wherein the corresponding product time window is a category time period determined for the product category.

In some cases, the product time window is associated with a high threshold and wherein if the category time period is above the threshold, the product time window is set according to the threshold.

In some cases, the category time period of a given category is a most frequent product time period out of product time periods calculated for each product associated with the given category, wherein each product time period is a number of consecutive time windows, so that the a percentage of units of the corresponding product sold during the consecutive time windows, out of a number of sold units of the corresponding product, is higher than a sales percentage threshold, and wherein the number of sold units is one of the entity-related parameters.

In some cases, each product is associated with a product category and wherein the corresponding product time window is a global time period determined for all products utilizing category time periods calculated for each product category.

In some cases, the product time window is associated with a high threshold and wherein if the global time period is above the threshold, the product time window is set according to the threshold.

In some cases, the global time period is a highest category time period out of category time periods associated with a largest number of products, wherein each category time period of a corresponding category is a most frequent product time period out of product time periods calculated for each product associated with the corresponding category, wherein each product time period is a number of consecutive time windows, so that the a percentage of units of the corresponding product sold during the consecutive time windows, out of a number of sold units of the corresponding product, is higher than a sales percentage threshold, and wherein the number of sold units is one of the entity-related parameters.

In some cases, the processor is further configured to check existence of a negative effect of implementing the recommendation relating to the selected product at the given location of the locations, and wherein the recommendation is provided if the negative effect is not existing.

In some cases, the recommendation to check behavior of the selected product at the given location includes one or more of the following action items:
a. check visibility of the selected product at the given location;
b. check availability of the selected product at the given location;
c. order items of the selected product to the given location;
d. increase order quantity of the selected product to the given location;
e. increase order frequency of the selected product to the given location;
f. change a price of the selected product at the given location;
g. change a location of the selected product at the given location; or
h. change a promotion of the selected product at the given location.

In accordance with a second aspect of the presently disclosed subject matter, there is provided a method for data analysis, the method comprising: obtaining data relating to a plurality of entities associated with a plurality of distinct locations, the data including a plurality of values of one or more entity-related parameters related to each entity of the entities at each location of the locations, each value representing a corresponding time period; calculating, by a processor, for a plurality of entity pairs of the entities, utilizing the values, an influence score indicative of a connection between at least one of the entity-related parameters of the entity pair at the plurality of locations; and generating, by the processor, utilizing the influence scores, one or more influence models, each describing influences between two or more of the entities and being usable for generating recommendations relating to at least one entity of the entities, wherein the influences are single-sided so that for each given entity of the entities and any other entity of the entities that is directly or indirectly influenced by the given entity according to the corresponding model, the given entity is not influenced by the other entity according to the corresponding influence model.

In some cases, each of the influence models is a simple weighted directed graph comprising a plurality of nodes, wherein each node of the nodes is associated with a distinct entity of the entities and each connection connecting a pair of the nodes is associated with a weight, the weight being associated with the influence score of the corresponding entities.

In some cases, the influence models are generated such that for each influence model of the influence models, a function of the weights associated with the influence model's connections exceeds a threshold.

In some cases, the function of the weights is a sum of the weights.

In some cases, the weight is the influence score.

In some cases, the entities are products and the entity-related parameters are product-related parameters including at least one of the following:
a. a number of sold amounts of the product;
b. a revenue generated from sale of the number of sold amounts of the product;
c. a profit generated from sale of the number of sold amounts of the product;
d. a number of stored amounts of the product;
e. a number of ordered amounts of the product;
f. a cost of purchase of the number of sold amounts of the product;
g. a forecasted sales amount;
h. a forecasted revenue from the forecasted sales amount;
i. a forecasted profit from the forecasted sales amount;
j. a forecasted number of stored amounts of the product;
k. a forecasted number of ordered amounts of the product; or
l. an interest indicative parameter.

In some cases, the method further comprises utilizing one or more additional parameter of the following additional parameters for generating the one or more influence models:
a. promotions relating to the product;
b. customer-related properties of the sold amount of the product;
c. customer-related properties of the ordered amount of the product;
d. shelf-related properties of the product;
e. customer grading of the product;
f. pricing information of the product;
g. packaging of the product;
h. recommendation implementation information, relating to the product at the location, received from a user at the location;
i. assortment of the product in the location;
j. training of staff at the location;
k. planogram of the location;
l. staff-related properties of the location.

In some cases, the entities are products and the method further comprises providing a recommendation relating to a selected product of the products, at a given location of the locations, utilizing the influence model.

In some cases, the recommendation is to introduce the selected product to the given location, the given location belonging to a group of two or more selected locations of the locations, wherein the selected product is not located at the given location and wherein introducing the selected product to the given location is expected to yield a high sales level of the selected product at the given location relative to locations that are not included in the group, wherein the group is determined utilizing the influence model.

In some cases, the recommendation is to check behavior of the selected product at the given location, the given location belonging to a group of two or more selected locations of the locations, wherein the selected product is located at the given location according to the data and wherein the given product at the given location is expected to, but does not, yield a high sales level relative to locations not included in the group, wherein the group is determined utilizing the influence model.

In some cases, the recommendation is to check behavior of the selected product at the given location, the given location belonging to a group of two or more selected locations of the locations, wherein the selected product is located at the given location according to the data and wherein the given product at the given location is expected to, but does not, yield a low sales level relative to locations not included in the group, wherein the group is determined utilizing the influence model.

In some cases, the recommendation is to remove the selected product from the given location, wherein the selected product is located at the given location according to the data and wherein a sales-related parameter of the product-related parameters of the selected product at the given location is lower than a minimal expected sales-related parameter calculated utilizing sales-related parameters of the selected product at a group of two or more selected locations of the locations, wherein the group is determined utilizing the influence model.

In some cases, the recommendation is to move the selected product, located at the given location, the given location belonging to a group of two or more selected locations of the locations, to a certain vicinity to a second product of the products located at the given location, wherein the selected product and the second product are located at the given location according to the data and wherein a combined sales level of the selected product and the second product is expected to be higher than a combined sales level of the selected product and the second product at locations that are not included in the group, wherein the group is determined utilizing (a) the influence model and (b) a products map of the products within the corresponding locations.

In some cases, the recommendation is to introduce the selected product to the given location, the given location belonging to a group of two or more selected locations of the locations, wherein the selected product is not located at the given location and wherein introducing the selected product to the given location is expected to yield a high sales level of at least one other product at the given location relative to locations that are not included in the group, wherein the group is determined utilizing the influence model.

In some cases, the group is determined so that for at least one other product, other than the selected product, the product-related parameter is within a boundary in each location of the group.

In some cases, the boundary is defined by a low threshold and a high threshold.

In some cases, the boundary is pre-determined.

In some cases, the boundary is dynamically calculated.

In some cases, the recommendation is to remove the selected product from the given location, wherein the selected product is located at the given location according to the data and wherein removing the selected product from the given location is expected to result in an increase of the sales of at least one second product at the given location wherein the increase of the sales of the second product results in increased profits at the given location.

In some cases, the recommendation is to change a pricing or a placement or a packaging or a number of stored amounts of the selected product, or to perform a promotion of the selected product, in the given location of the locations, wherein the selected product is located at the given location according to the data and wherein acting upon the recommendation is expected to increase profits at the at the given location.

In some cases, the method further comprises monitoring implementation of the recommendation.

In some cases, the entities are products and wherein each product of the products is associated with a corresponding product time window usable for determining the plurality of values of the product-related parameters related to the product to be used for calculating the influence scores.

In some cases, the product time window is a number of consecutive time windows, so that a percentage of units of the product sold during the consecutive time windows, out of a number of sold units of the product, is higher than a sales percentage threshold, and wherein the number of sold units is one of the entity-related parameters.

In some cases, the product time window is associated with a high threshold and wherein if the number of consecutive time windows is above the threshold, the time period is set according to the threshold.

In some cases, the product time window is a most frequent number of consecutive time periods out of numbers of consecutive time periods calculated for each product, so that a percentage of units of the corresponding product sold during the consecutive time periods, out of a number of sold units of the corresponding product, is higher than a sales percentage threshold, and wherein the number of sold units is one of the entity-related parameters.

In some cases, the product time window is associated with a high threshold and wherein if the most frequent number of consecutive time windows is above the threshold, the product time window is set according to the threshold.

In some cases, each product is associated with a product category and wherein the corresponding product time window is a category time period determined for the product category.

In some cases, the product time window is associated with a high threshold and wherein if the category time period is above the threshold, the product time window is set according to the threshold.

In some cases, the category time period of a given category is a most frequent product time period out of product time periods calculated for each product associated with the given category, wherein each product time period is a number of consecutive time windows, so that the a percentage of units of the corresponding product sold during the consecutive time windows, out of a number of sold units of the corresponding product, is higher than a sales percentage threshold, and wherein the number of sold units is one of the entity-related parameters.

In some cases, each product is associated with a product category and wherein the corresponding product time window is a global time period determined for all products utilizing category time periods calculated for each product category.

In some cases, the product time window is associated with a high threshold and wherein if the global time period is above the threshold, the product time window is set according to the threshold.

In some cases, the global time period is a highest category time period out of category time periods associated with a largest number of products, wherein each category time period of a corresponding category is a most frequent product time period out of product time periods calculated for each product associated with the corresponding category, wherein each product time period is a number of consecutive time windows, so that the a percentage of units of the corresponding product sold during the consecutive time windows, out of a number of sold units of the corresponding product, is higher than a sales percentage threshold, and wherein the number of sold units is one of the entity-related parameters.

In some cases, the method further comprises checking existence of a negative effect of implementing the recommendation relating to the selected product at the given location of the locations, and wherein the recommendation is provided if the negative effect is not existing.

In some cases, the recommendation to check behavior of the selected product at the given location includes one or more of the following action items:
a. check visibility of the selected product at the given location;
b. check availability of the selected product at the given location;
c. order items of the selected product to the given location;
d. increase order quantity of the selected product to the given location;
e. increase order frequency of the selected product to the given location;
f. change a price of the selected product at the given location;
g. change a location of the selected product at the given location; or
h. change a promotion of the selected product at the given location.

In accordance with a third aspect of the presently disclosed subject matter, there is provided a non-transitory computer readable storage medium having computer readable program code embodied therewith, the computer readable program code, executable by at least one processor of a computer to perform a method comprising: obtaining data relating to a plurality of entities associated with a plurality of distinct locations, the data including a plurality of values of one or more entity-related parameters related to each entity of the entities at each location of the locations, each value representing a corresponding time period; calculating, by a processor, for a plurality of entity pairs of the entities, utilizing the values, an influence score indicative of a connection between at least one of the entity-related parameters of the entity pair at the plurality of locations; and generating, by the processor, utilizing the influence scores, one or more influence models, each describing influences between two or more of the entities and being usable for generating recommendations relating to at least one entity of the entities, wherein the influences are single-sided so that for each given entity of the entities and any other entity of the entities that is directly or indirectly influenced by the given entity according to the corresponding model, the given entity is not influenced by the other entity according to the corresponding influence model.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of the system environment, in accordance with the presently disclosed subject matter;

FIG. 2 is a schematic illustration of an influence model generated using the obtained data, in accordance with the presently disclosed subject matter;

FIG. 3 is a block diagram schematically illustrating one example of a system for data analysis, in accordance with the presently disclosed subject matter;

FIG. 4 is a flowchart illustrating one example of a sequence of operations carried out for generating one or more influence models, in accordance with the presently disclosed subject matter;

FIG. 5 is a flowchart illustrating one example of a sequence of operations carried out for providing a recommendation relating to a certain entity located at a certain location, in accordance with the presently disclosed subject matter;

FIG. 6 is a flowchart illustrating one example of a sequence of operations carried out for determining recommendations, in accordance with the presently disclosed subject matter;

FIG. 7 is a flowchart illustrating one example of a sequence of operations carried out for determining a product time window, in accordance with the presently disclosed subject matter;

FIG. 8 is a flowchart illustrating one example of a sequence of operations carried out for determining an expected negative effect of implementing a given recommendation, in accordance with the presently disclosed subject matter;

FIG. 9 is a flowchart illustrating one example of a sequence of operations carried out for merging recommendations generated for two different product definition levels, in accordance with the presently disclosed subject matter; and

FIG. 10 is a flowchart illustrating one example of a sequence of operations carried out for cross validating recommendations, in accordance with the presently disclosed subject matter.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “calculating”, “generating”, “utilizing”, “providing”, “monitoring”, “checking” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

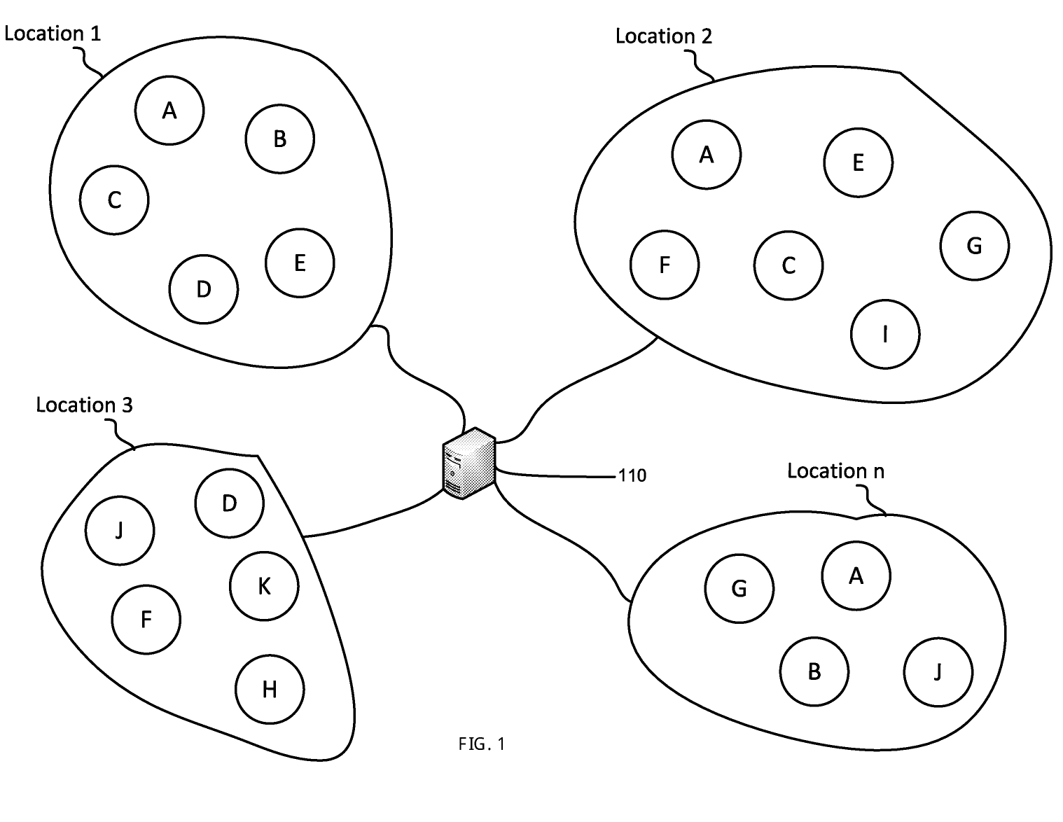

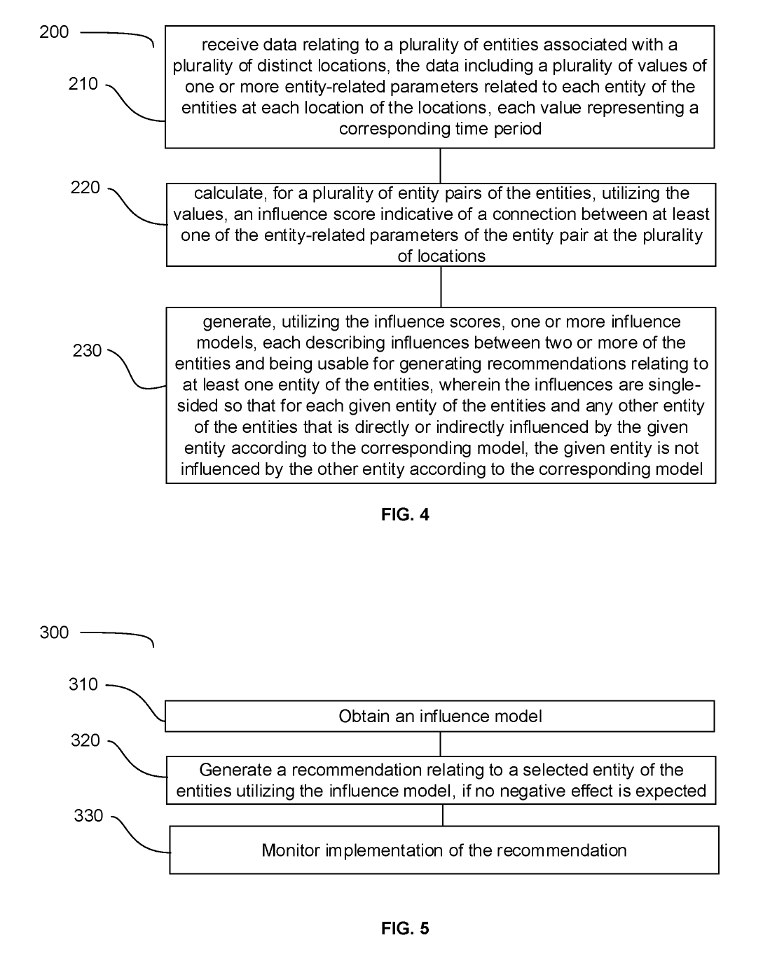

In embodiments of the presently disclosed subject matter, fewer, more and/or different stages than those shown in FIGS. 4-10 may be executed. In embodiments of the presently disclosed subject matter, one or more stages illustrated in FIGS. 4-10 may be executed in a different order and/or one or more groups of stages may be executed simultaneously. FIGS. 1 and 3 illustrate a general schematic of the system architecture in accordance with an embodiment of the presently disclosed subject matter. Each module in FIG. 3 can be made up of any combination of software, hardware and/or firmware that performs the functions as defined and explained herein. The modules in FIG. 3 may be centralized in one location or dispersed over more than one location. In other embodiments of the presently disclosed subject matter, the system may comprise fewer, more, and/or different modules than those shown in FIG. 3.

Bearing this in mind, attention is drawn to FIG. 1, showing a schematic illustration of the system environment, in accordance with the presently disclosed subject matter.

According to certain examples of the presently disclosed subject matter, and as further detailed herein, inter alia with reference to FIG. 4, the system 100 can obtain (e.g. receive or retrieve from a data repository accessible by the system 100) data relating to various entities associated with various locations. In the following description, reference is made to the retail world, in which the entities are products and the locations are store locations (e.g. of real-world stores and/or virtual on-line stores belonging to a certain chain of stores, such as Walmart, etc.), however, it is to be emphasized that this is by no means limiting, as the entities can be other types of entities (such as, coupons, ads, services, plans, sites, key words, etc.) and the locations can be other types of locations (such as, customers, projects, companies, teams, etc.), mutatis mutandis. In addition, the products can be stock keeping units (SKUs), or a more general unit such as a specific model (that, in the fashion industry for example, can have multiple colors and multiple sizes) or a specific model and color (that, in the fashion industry for example, can have multiple sizes).

In the illustrated example, n locations exist, out of which four are shown: location 1, location 2, location 3 and location n. It is to be noted that in some cases more, or less, locations can exist. Furthermore, in the illustrated example, each location comprises a group of products, as follows: location 1 comprises five products: product A, product B, product C, product D and product E; location 2 comprises six products: product A, product C, product E, product F, product G and product I; location 3 comprises five products: product D, product F, product H, product J and product K; and location n comprises four products: product A, product B, product G and product J.

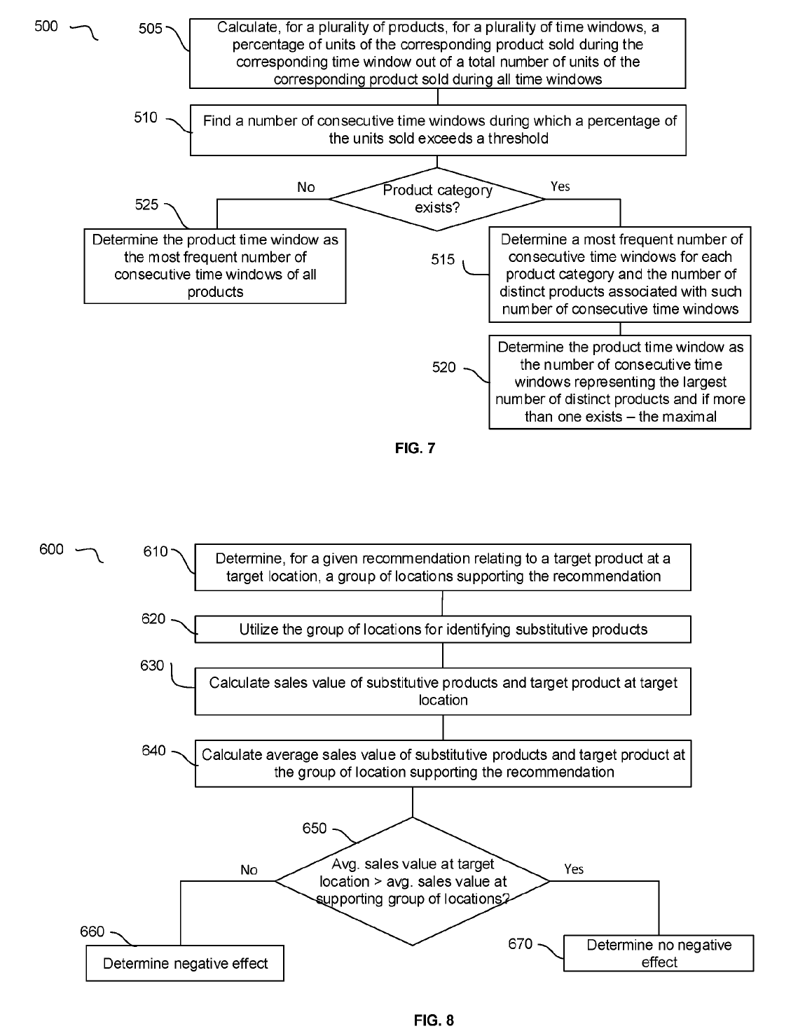

In some cases, the data obtained by the system 100 can include a plurality of values of at least one entity-related parameter (also referred to herein interchangeably as product-related parameter) relating to each product (in some cases for at least two products, and preferably for at least five products) at each location (in some cases for at least six locations), each value representing a corresponding value time period (e.g. a certain amount of minutes, a certain amount of hours, a certain amount of days, a certain amount of weeks, etc.), within a corresponding time window (also referred to herein as “product time window”) that can optionally be determined for each product (as further detailed herein with reference to FIG. 7).

The entity-related parameters can include, for example (non-limiting), one or more of the following:
a. a number of sold amounts (e.g. in terms of units or weights) of the product at the corresponding location;
b. a revenue generated from sale of the number of sold amounts of the product at the corresponding location;
c. a profit generated from sale of the number of sold amounts of the product at the corresponding location;
d. a number of stored amounts (e.g. inventories, in terms of units or weights) of the product at the corresponding location;
e. a number of ordered amounts of the product (ordered for example by a user of the system), ordered to the corresponding location.
f. a cost of purchase of the number of sold amounts of the product at the corresponding location;
g. any other derivative of the number of sold amounts of the product at the corresponding location;
h. a forecasted sales amount (e.g. in terms of units or weights) of the product at the corresponding location;
i. a forecasted revenue expected to be generated from the forecasted sales amount of the product at the corresponding location;
j. a forecasted profit expected to be generated from the forecasted sales amount of the product at the corresponding location;
k. a forecasted number of stored amounts of the product (e.g. inventories, in terms of units or weights) of the product at the corresponding location;
l. a forecasted number of ordered amounts of the product (e.g. inventories, in terms of units or weights) of the product at the corresponding location;
m. one or more interest indicative parameters indicative of a demand or an interest of customers in the product, such as number of visits of the customer to a vicinity of the product at the corresponding location (e.g. obtained utilizing a vicinity sensor), a number of queries (e.g. on-line queryies) relating to the product at the corresponding location, etc.; or
n. One or more scores calculated utilizing information of the timely change of the sold amount.

Looking at a non limiting example, the data can include, for each product at each location, a plurality of values, each indicative of a number of sold units of a product sold at the corresponding location at a corresponding time period within a corresponding product time window. Considering product A for example: Product A is being sold at locations 1, 2 and n. The data relating to product A can include, for example, for a certain time window (calculated for example as further detailed herein with reference to FIG. 7), comprising a plurality of time periods, indication of a number of sold units sold on each time period during the time window, on each location product A is being sold (i.e. locations 1, 2 and n). Assuming for example that the product time window for product A is three days, and the time period is one day, the data can include, for each of the locations 1, 2 and n, a first value indicative of a number of units of product A sold at the location at day one, a second value indicative of a number of units of product A sold at the location at day two and a third value indicative of a number of units of product A sold at the location at day three, for a total of nine values of the parameter, one for each time period at each location.

In some cases, the system 100 can obtain values of additional parameters, such as one or more of the following (non-limiting):

### 1. Location Properties:

1.1. Assortment of the product at the corresponding location (as in some cases the product assortments can be different at different locations);
1.2. Training of staff at the location (as in some cases the training of the staff can be different at different locations, as for example staff at certain locations can be trained to sell a certain product whereas at other locations the staff may not have been trained accordingly);
1.3. Staff-related properties of the location (e.g. age, sex, home address, profession, education, marital status, etc. of the staff at the corresponding location);
1.4. Sales method of the product at the location (e.g. various products can be sold Over The Counter, near the Register, Self purchase, by a sales person in the aisles, etc.);
1.5. Customer traffic in location (e.g. number of customers passing through aisle during a certain time window, number of customers passing through lines during a certain time window, number of customers standing in queues during a certain time window, median/average/aggregate/maximal/minimal waiting time of customers in queues, number of cars entering a parking facility of the location during a certain time window, etc.);
1.6. Customer-related properties of the sold amount of the product at the corresponding location (e.g. age, sex, home address, profession, education, marital status, etc. of the customers that purchased the product at the corresponding location);
1.7. Customer-related properties of the ordered amount (e.g. ordered by customers via an internet website, etc.) of the product at the corresponding location (e.g. age, sex, home address, profession, education, marital status, etc. of the customers that purchased the product at the corresponding location);
1.8. recommendation implementation information (indicative of whether a recommendation provided with regard to the location, e.g. as further detailed herein, was implemented or not, etc.), relating to the product at the location, received from a user (e.g. a location manager) at the location (e.g. utilizing a mobile application installed on the location manager's phone, etc.);
1.9. Location hierarchy information (Store Format, Store Manager, Store Type, Store Geographic Data, etc.)

### 2. Product Properties:

2.1. Packaging of the product at the corresponding location (as in some cases the same product can have different packaging at different locations);
2.2. Planogram of the location (as different locations can have different planograms);
2.3. Product Hierarchy (e.g. Category, Sub Category, Brand, etc.);
2.4. Customers grading of the product (e.g. grading indicative of satisfaction from the product, appearance of the product, quality of the product, etc.);
2.5. Shelf-related properties of the product (e.g. number of items of the product on a shelf on which the product is placed, distance from other products placed on the same shelf or on other shelves, etc.); or
2.6. A stability factor of the product, considering the randomness of this product in the set of locations.

### 3. Sales Properties:

3.1. Pricing information of the product at the corresponding location (as in some cases the same product can have a different price at different locations);
3.2. Promotions relating to each product at the corresponding location (as in some cases various promotions, such as discounts, advertisements, etc. can be performed at part of the locations and not at other locations).

According to certain examples of the presently disclosed subject matter, the entity-related parameters values can be received by the system 100 directly from computerized systems located at each location (e.g. via a wired/wireless connection, or off-line, e.g. using appropriate hardware such as hard drives), or indirectly, e.g. via a centralized computerized system that obtains the data from the locations in any manner (e.g. via a wired/wireless connection, or off-line, e.g. using appropriate hardware such as hard drives).

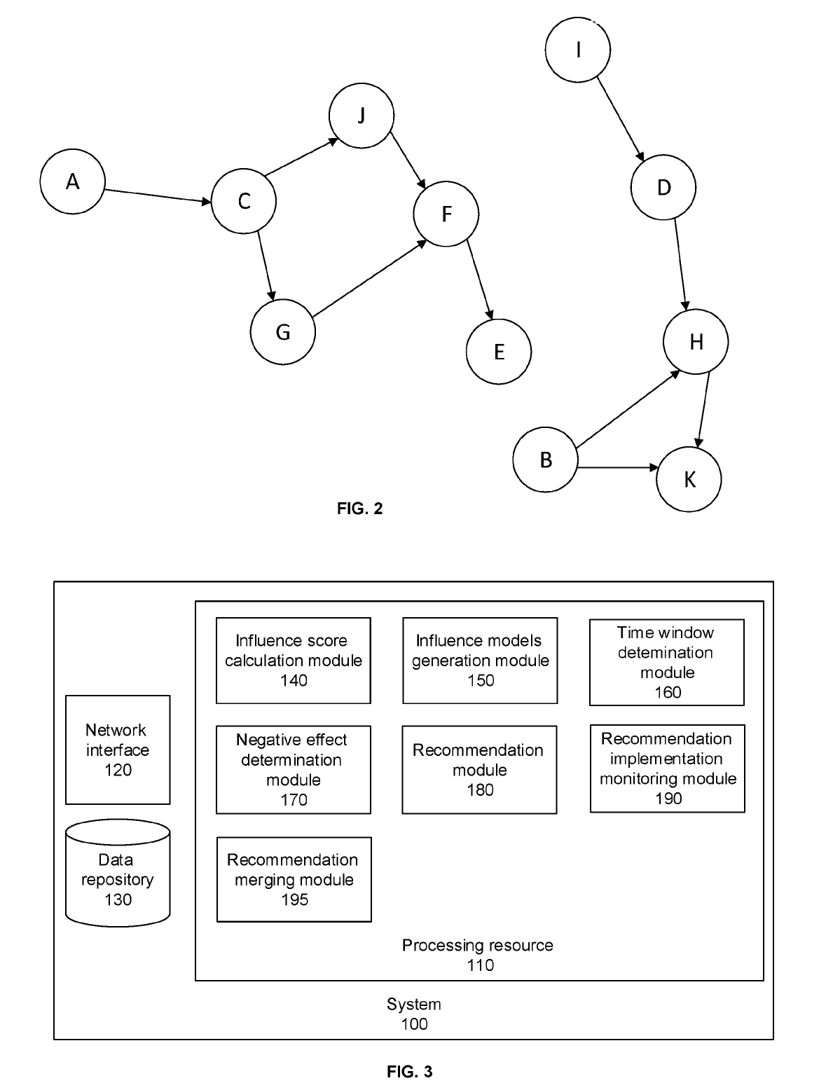

Having described the system environment, attention is now drawn to FIG. 2, showing a schematic illustration of an influence model generated using the obtained data, in accordance with the presently disclosed subject matter.

According to certain examples of the presently disclosed subject matter, system 100 can be configured to utilize the values of the entity-related parameters for generating one or more influence models, each describing influences (e.g. correlations, inverse correlation, Mutual Information, Brownian Distance, Covariance Distance, Cosine Similarity, Minkowski Distance, etc.) between two or more of the products, as further detailed herein, inter alia with reference to FIG. 4.

In the illustrated example, provided for illustrative purposes only, two influence models have been generated (in accordance with the influence models generation process described with reference to FIG. 4). The first influence model indicates the following:
a. product A influences product C;
b. product C influences products G and J;
c. products G and J influence product F; and
d. product F influences product E.

The second influence model indicates the following:
a. product I influences product D;
b. products B and D influence product H; and
c. products B and H influence product K.

In some cases, each influence can be explained by an influence score, which indicates the strength of the influence (Full/Partial influence). In some cases, the influence score can be normalized between zero to one, zero optionally indicating no influence, and one optionally indicating a full influence.

Looking at product A for example, the influence of product A on product C can be, for example, a correlation. Such influence can indicate that when product A is sold at a certain level (e.g. a high level above a certain threshold or a low level below a certain threshold, or a mid-level between low and high thresholds, etc.), product C is expected to be sold at a corresponding level.

alternatively, the influence of product A on product C can be, for example, an inverse (negative) correlation. Such influence can indicate that when product A is sold at a certain level (e.g. a high level above a certain threshold or a low level below a certain threshold, or a mid-level between low and high thresholds, etc.), product C is expected to be sold at an opposite level (e.g. when product A is sold at a high level, above a certain threshold, product C is sold at a low level, below a certain threshold).

Looking at product K for example, it is directly influenced by Product B and Product H. It is also indirectly influenced by Product D and Product I. Such influence can be, for example, the Brownian Distance between the products. The influence can indicate, for example, that when Product D sells at a low level, it causes Product H to sell at a Medium level, which in turn causes Product K to sell at a High level.

It is to be noted that in some cases, the influences are single-sided so that for each given product of the products (e.g. product B) and any other product of the products (e.g. product K) that is directly or indirectly influenced by the given product (e.g. product B) according to the corresponding model, the given product (e.g. product B) is not influenced by the other product (e.g. product K) according to the corresponding influence model.

As further detailed herein, inter alia with reference to FIG. 5, system 100 can be configured to utilize the influence models for providing recommendations relating to products, at given locations of the locations.

Turning to FIG. 3, there is shown a block diagram schematically illustrating one example of a system for data analysis, in accordance with the presently disclosed subject matter.

According to certain examples of the presently disclosed subject matter, the system 100 can comprise one or more network interfaces 120 enabling connecting the system 100 to one or more communication networks and enabling it to send and receive data sent thereto through such communication networks, including sending and/or receiving product-related data as detailed herein, inter alia with reference to FIG. 1.

system 100 can further comprise, or be otherwise associated with, a data repository 130 (e.g. a database, a storage system, a memory including Read Only Memory—ROM, Random Access Memory—RAM, or any other type of memory, etc.) configured to store data, including inter alia the product-related parameters, the influence models, and more, as further detailed herein. In some cases, data repository 130 can be further configured to enable retrieval and/or update and/or deletion of the stored data. It is to be noted that in some cases, data repository 130 can be distributed.

System 100 further comprises one or more processing resources 110. Processing resource 110 can be one or more processing units (e.g. central processing units), microprocessors, microcontrollers or any other computing devices or modules, including multiple and/or parallel and/or distributed processing units, which are adapted to independently or cooperatively process data for controlling relevant system resources and for enabling operations related to system resources.

The processing resource 110 can comprise one or more of the following modules: influence score calculation module 140, influence models generation module 150, time window determination module 160, negative effect determination module 170, recommendation module 180, recommendation implementation monitoring module 190, and recommendation merging module 195.

According to some examples of the presently disclosed subject matter, influence score calculation module 140 can be configured to calculate influence scores for product pairs, as further detailed herein, inter alia with reference to FIG. 4. In some cases, the influence scores can be calculated utilizing a plurality of values of one or more product-related parameters related to each product of the products at each location of the locations, each value representing a corresponding time period (e.g. assuming the product-related parameter is a number of sold units, exemplary values of the parameter can be the number of sold units on each day during a time window determined by the time window determination window 160, as further detailed herein). The influence score can be indicative of a connection between at least one of the product-related parameters of the product pair at the plurality of locations.

According to some examples of the presently disclosed subject matter, influence models generation module 150 can be configured to generate one or more influence models, each describing influences between two or more of the products and being usable for generating recommendations relating to at least one product of the products, as further detailed herein, inter alia with reference to FIG. 4.

According to some examples of the presently disclosed subject matter, time window determination module 160 can be configured to determine a product time window usable for determining a sub-group of values of the product-related parameters relating to each product to be used for calculating the influence scores, out of the available values of the product-related parameters relating to each product, as further detailed herein, inter alia with reference to FIG. 7.

According to some examples of the presently disclosed subject matter, negative effect determination module 170 can be configured to determine an expected negative effect of implementing a given recommendation, as further detailed herein, inter alia with reference to FIG. 8.

According to some examples of the presently disclosed subject matter, recommendation module 180 can be configured to generate recommendations relating to at least one product of the products, as further detailed herein, inter alia with reference to FIG. 5.

According to some examples of the presently disclosed subject matter, recommendation implementation monitoring module 190 can be configured to monitor implementation of the recommendations generated by the recommendation module, as further detailed herein, inter alia with reference to FIG. 5.

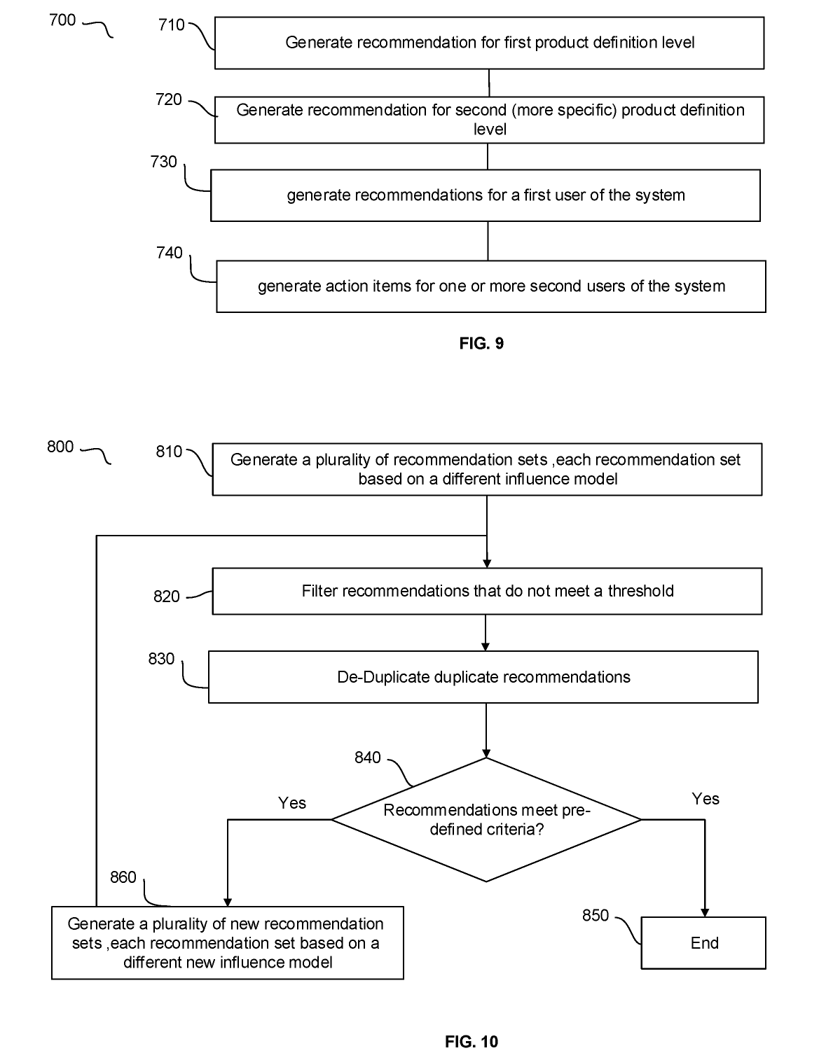

According to some examples of the presently disclosed subject matter, recommendation merging module 195 can be configured to merge recommendations generated for two different product definition levels, as further detailed herein, inter alia with reference to FIG. 9.

It is to be noted that in some cases all or part of the modules can be distributed between processing resources of the system 100.

Having described the system architecture, attention is now drawn to FIG. 4, where a flowchart illustrating one example of a sequence of operations carried out for generating one or more influence models, in accordance with the presently disclosed subject matter, is provided.

According to some examples of the presently disclosed subject matter, system 100 can be configure to perform an influence models generation process 200, e.g. utilizing the influence models generation module 150

For that purpose, system 100 can be configured to obtain data relating to a plurality of entities associated with a plurality of distinct locations, the data including a plurality of values of one or more entity-related parameters related to each entity of the entities at each location of the locations, each value representing a corresponding time period (block 210). A more detailed explanation about the obtained data is provided herein with respect to FIG. 1.

In some cases, all of the locations can be locations associated with a single retailer, and in other cases, at least one location can be associated with a first retailer, and at least one other location can be associated with a second retailer, other than the first retailer. Looking at a specific example, the first retailer can be Target, having a plurality of stores (locations), and the second retailer can be Wallgreens, also having a plurality of stores (locations) other than Target's stores. Utilizing locations of different retailers for generating the influence model will enable the system 100 to provide recommendations to each retailer also outside the scope of the entities that are in his variety. It is to be further noted that although in the example above only two retailers have been discussed, using more than two retailers locations is also contemplated.

In some cases, the user of the system 100 can instruct the system 100 to perform a preliminary stage in which one or more virtual entities, being a group of two or more entities, are created. The virtual entities are formed of two or more entities whose behavior indicates that the aggregated demand thereof is substantially (e.g. based on a user-defined threshold of difference between the expected variability of the aggregated demand of the entities combined into the virtual entity and the actual variability of the aggregated demand of the entities combined into the virtual entity) more constant than the demand for each separate entity. For example, entity A's sales standard deviation is 30, and entity B's standard deviation is 40, the expected standard deviation of A's+B's sales together is \sqrt{30²+40²}=50, while the actual standard deviation of A's+B's sales together is 25, and the user defined threshold is 10% difference. In the exemplary case, the difference is 50−25/50=50% and therefore, entities A and B will be combined to form a new virtual entity for the purpose of generating the influence model. It is to be noted that a virtual entity can be generated for more than two entities, one or more of which can be virtual entities themselves.

In some cases, the values can be discretisized. For example, assuming the product-related parameter is a number of sold units of the product, the values can be translated to a pre-determined number of discrete values. For example, each value of the values can be translated to one of the following values: (1) a first value indicative of a low sales level, in which the number of sold units is below a certain low threshold; (2) a second value indicative of a middle sales level, in which the number of sold units is above the low threshold and below a certain high threshold; and (3) a third value indicative of a high sales level, in which the number of sold units is above the high threshold. It is to be noted that this is merely an example, and the values can optionally be discretisized in any other manner.

In some cases, system 100 (e.g. utilizing influence score calculation module 140) can be further configured to utilize the values obtained at block 210 (or the discretisized values, if such were calculated) for calculating, for a plurality of product pairs of the products, an influence score indicative of a connection (e.g. correlations, inverse correlation, Mutual Information, Brownian Distance, Covariance Distance, Cosine Similarity, Minkowski Distance, etc.) between at least one of the entity-related parameters of the entity pair at the plurality of locations (block 220).

Let's look at an example of a pair of products, product X and product Y, both being sold at sixty locations, and let's assume that the product-related parameter is a number of sold units of the product and that the values are discretisized to low sales level, middle sales level and high sales level.

In a first case, both products behave similarly in all sixty locations, i.e. when product X is sold at a certain sales level (e.g. low/middle/high), product Y is always sold at a constant sales level (e.g. low/middle/high, and not necessarily the same sales level as X). In such case, the influence score for the pair of products X and Y can be the highest possible score as they are fully dependent.

In a second case, the products do not behave similarly in all sixty locations, however in 80% of the cases, when product X is sold at a certain sales level, product Y is sold at a constant sales level. In such case the influence score is expected to be lower than the influence score calculated in the first case.

In a third case, the products do not behave similarly in all sixty locations, however in 50% of the cases, when product X is sold at a certain sales level, product Y is sold at a constant sales level. In such case the influence score is expected to be lower than the influence score calculated in the second case.

In a fourth case, not only that the products do not behave similarly in all sixty locations, when product X is sold at a certain sales level, product Y is sold at a low sales level at twenty locations, at a middle sales level at another twenty locations and at a high sales level at the remaining twenty locations. In such cases, the influence score for the pair of products X and Y is the lowest possible score, as there is apparently no influence of the sales level of product X on the sales level of product Y.

In the illustrated example, the stronger the relationship is between a pair of products—the higher the influence score will be. It is to be noted that this is by no means binding and in some cases the stronger the relationship is between a pair of products—the lower the influence score will be (for example with a distance metric). In any case, we do expect the Influence score to be correlated with the strength of the relationship between the products.

In some cases, the system 100 can be further configured to calculate influence scores, indicative of connections between products and various parameters relating to the products and/or the locations and/or the sales of the products at the locations.

According to some examples of the presently disclosed subject matter, system 100 can utilize the influence scores, calculated for the plurality of product pairs at block 220, for generating one or more influence models, each describing influences between two or more of the products and being usable for generating recommendations relating to at least one product of the products (block 230). In some cases, the influences are single-sided so that for each given product of the products and any other product of the products that is directly or indirectly influenced by the given product according to the corresponding model, the given product is not influenced by the other product according to the corresponding influence model.

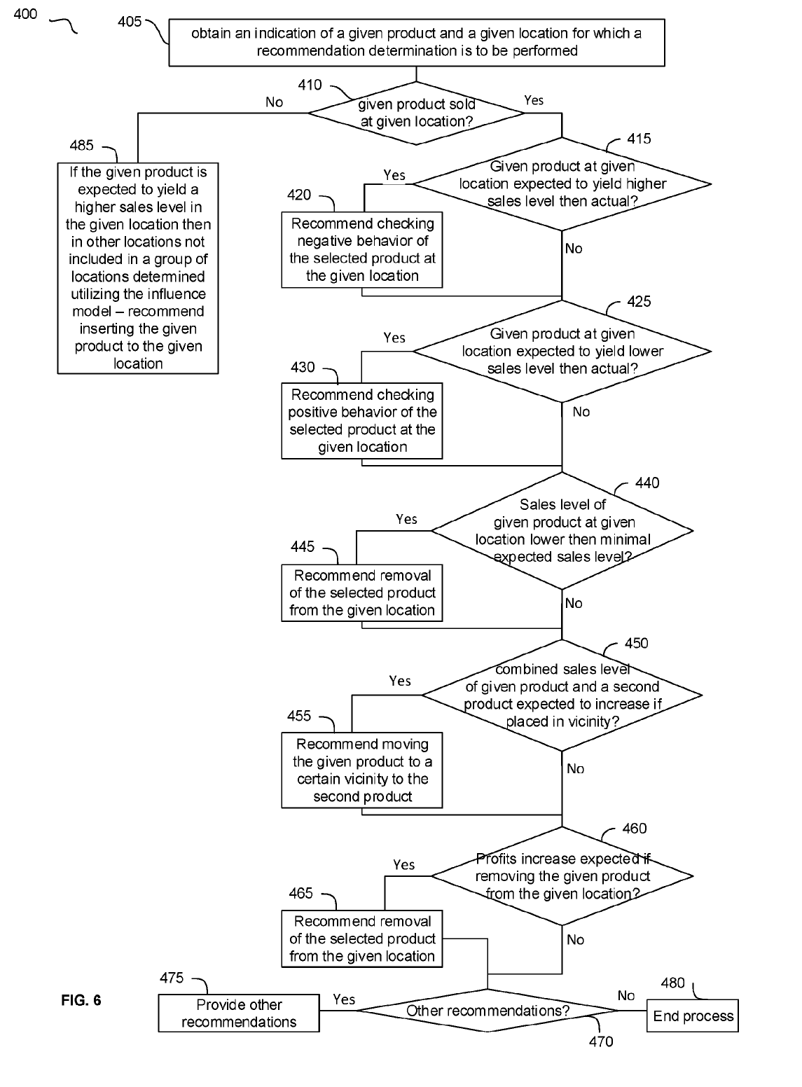

One exemplary reason for restricting the influences to be single-sided is that allowing two-sided influences may result in conflicting recommendations (the recommendation process is described herein inter alia with reference to FIGS. 5 and 6). Assuming that: (1) product X affects product Y so that according to the influence model when product X sells at a low level—product Y is expected to sell at a high level and vice versa; (2) product Y affects product X so that according to the influence model when product Y sells at a low level—product X is expected to sell at a high level and vice versa; and (3) at a given location—both product X and product Y sell at a low level. In such case, the system may provide a recommendation aimed at increasing the sales level of product X at the given location, and another recommendation aimed at increasing the sales level of product Y at the given location, however, it may be impossible to implement both recommendations as increasing the sales level of both product X is expected to lower the sales level of product Y and vice versa.

In some cases, based on two or more influence models, for a given pair of products, an opposite influence may be detected. For example, according to influence model I, product A affects product B, and according to influence model II, product B affects product A. In such cases, conflicting recommendations may be generated (e.g. according to the process described in FIG. 5.). In such cases, the system 100 can be configured to resolve such conflicts, for example by ignoring the recommendation with the lower statistical significance.

It is to be noted that in some cases the influence models are simple weighted directed graphs (that are not necessarily complete and/or balanced) comprising a plurality of nodes, wherein each node of the nodes is associated with a distinct product of the products and each connection connecting a pair of the nodes is associated with a weight that is associated with the influence score of the corresponding products pair. In more particular cases, the weight is the influence score itself.

It is to be further noted that in some cases the influence models are generated such that for each influence model of the influence models, a function (e.g. sum) of the weights associated with the influence model's connections exceeds a threshold.

For example, the threshold can be calculated by the following exemplary procedure:
A. for each product of the products, sum the influence scores of the product vs. each of the other products.
B. Sort the results in a descending order of sums.
C. Set threshold=0
D. Starting from the product with the highest sum to the product with the lowest sum do:
   a. Set s to be the best influence score of the product vs. each of the other products
   b. Set threshold=threshold+s

It is to be noted in this respect that the “best” influence score, depends on the selected influence scoring method. If a higher score indicates a stronger relationship, than the maximal value is considered the best value. If a lower score indicates a stronger relationship, then the minimal value is considered the best value.

In some cases, additional parameters can define (a) a maximal number of outgoing connections connecting a given node (representing a corresponding product) to other nodes (representing other products); and (b) a maximal number of incoming connections connecting nodes (representing products) to a given node (representing a corresponding product). In such cases, the system 100 can generate the influence models such that: (a) in case according to the influence scores there exists more outgoing connections connecting a given product to other products than the maximal number of outgoing connections allowed—only the maximal number of outgoing connections with the highest weights will remain and the others will be pruned; and (b) in case according to the influence scores there exists more incoming connections connecting products to a given products than the maximal number of incoming connections allowed—only the maximal number of incoming connections with the highest weights will remain and the others will be pruned.

It is to be noted that in some cases various methods and techniques can be employed to prevent overfitting of the model. One exemplary method includes using Cross Validations. With Cross Validations, a part of the data is left out as a testing set. For example, in five fold cross validation, each data sample will be used 4 times in the training set, and one time in the testing set. The model is built on the training set alone. The influence models that were detected in the training set are tested against the testing set. If this influence does not exist in the testing set, it will be dropped from the influence model. An more elaborated example of a process including cross validation is provided herein, with reference to FIG. 10.

In some case, various methods and techniques may be used for increasing the statistical power of the models, for example boosting (see for example Freund, Y., & Schapire, R. E. (1997). A decision-theoretic generalization of on-line learning and an application to boosting. Journal of computer and system sciences, 55(1), 119-139), bootstrapping (see for example Efron, B., & Tibshirani, R. J. (1994). An introduction to the bootstrap. CRC press) and bagging (see for example Breiman, L. (1996). Bagging predictors. Machine learning, 24(2), 123-140) and cross validations.

An example of influence models is provided with reference to FIG. 2.

As indicated above, in some cases the system 100 can calculate influence scores, indicative of connections between products and various parameters relating to the products and/or the locations and/or the sales of the products at the locations. In such cases, the system can additionally or alternatively generate influence models based on the influence scores calculated for such connections. In such cases, the parameters can include one or more of the “additional parameters” detailed with reference to FIG. 1.

For exemplary purposes, let's look at a non-limiting and simplified example of the influence models generation process 200:

Assuming the following influence scores have been calculated for the products Banana (B), Juice (C), Sandwich (S) and Apple (A):

| | Product | | | |
|---|---|---|---|---|
| Product | Banana (B) | Juice (J) | Sandwich (S) | Apple (A) |
| Banana (B) | 0 | 0.3 | 0.6 | 0.2 |
| Juice (J) | 0.3 | 0 | 0.5 | 0.1 |
| Sandwich (S) | 0.6 | 0.5 | 0 | 0.9 |
| Apple (A) | 0.2 | 0.1 | 0.9 | 0 |

Given the above influence scores, the following table shows the possible combinations of influences (and corresponding influence score) between the products, and the sum of weights of each combination:

| | | | | Link1 | Link2 | Link3 | Sum of |
|---|---|---|---|---|---|---|---|
| | | | | influence | influence | influence | influence |
| Combination | Link1 | Link2 | Link3 | score | score | score | scores |
| B→J→S→A | B→J | J→S | S→A | 0.3 | 0.5 | 0.9 | 1.7 |
| B→J→A→S | B→J | J→A | A→S | 0.3 | 0.1 | 0.9 | 1.3 |
| B→S→J→A | B→S | S→J | J→A | 0.6 | 0.5 | 0.1 | 1.2 |
| B→S→A→J | B→S | S→A | A→J | 0.6 | 0.9 | 0.1 | 1.6 |
| B→A→J→S | B→A | A→J | J→S | 0.2 | 0.1 | 0.5 | 0.8 |
| B→A→S→J | B→A | A→S | S→J | 0.2 | 0.9 | 0.5 | 1.6 |
| J→B→S→A | J→B | B→S | S→A | 0.3 | 0.6 | 0.9 | 1.8 |
| J→B→A→S | J→B | B→A | A→S | 0.3 | 0.2 | 0.9 | 1.4 |
| J→S→B→A | J→S | S→B | B→A | 0.5 | 0.6 | 0.2 | 1.3 |
| J→S→A→B | J→S | S→A | A→B | 0.5 | 0.9 | 0.2 | 1.6 |
| J→A→B→S | J→A | A→B | B→S | 0.1 | 0.2 | 0.6 | 0.9 |
| J→A→S→B | J→A | A→S | S→B | 0.1 | 0.9 | 0.6 | 1.6 |
| S→B→J→A | S→B | B→J | J→A | 0.6 | 0.3 | 0.1 | 1 |
| S→B→A→J | S→B | B→A | A→J | 0.6 | 0.2 | 0.1 | 0.9 |
| S→J→B→A | S→J | J→B | B→A | 0.5 | 0.3 | 0.2 | 1 |
| S→J→A→B | S→J | J→A | A→B | 0.5 | 0.1 | 0.2 | 0.8 |
| S→A→B→J | S→A | A→B | B→J | 0.9 | 0.2 | 0.3 | 1.4 |
| S→A→J→B | S→A | A→J | J→B | 0.9 | 0.1 | 0.3 | 1.3 |
| A→B→J→S | A→B | B→J | J→S | 0.2 | 0.3 | 0.5 | 1 |
| A→B→S→J | A→B | B→S | S→J | 0.2 | 0.6 | 0.5 | 1.3 |
| A→J→B→S | A→J | J→B | B→S | 0.1 | 0.3 | 0.6 | 1 |
| A→J→S→B | A→J | J→S | S→B | 0.1 | 0.5 | 0.6 | 1.2 |
| A→S→B→J | A→S | S→B | B→J | 0.9 | 0.6 | 0.3 | 1.8 |
| A→S→J→B | A→S | S→J | J→B | 0.9 | 0.5 | 0.3 | 1.7 |

In the example illustrated in the table, the combinations J→B→S→A (i.e. Juice (J) influences Banana (B), which in turn influences Sandwich (S), which in turn influences Apple (A)) and A→S→B→J (i.e. Apple (A) influences Sandwich (S), which in turn influences Banana (B), which in turn influences Juice (J)) have the maximal sum of influence scores (1.8 in the illustrated example) and therefore, any one of these combinations can be selected (e.g. arbitrarily) as the influence model of these products. In some cases, it may be enough to determine the influence model as the first calculated combination whose sum of influence scores exceeds a threshold.

In some cases, it may be desirable to derive, from the generated influence models, a one-arc influence model for a given product. In such cases, for exemplary purposes, we can select, for the given product, the one product that is associated with the highest influence score with the required product out of the products that influence the given product according to the influence model. Looking at the influence model J→B→S→A detailed herein, the following one-arc influence models can be derived:

For Juice (J) there is no one-arc influence model, as no other produce influences Juice (J); For Banana (B), the one-arc influence model is J→B, as the only product that influences Banana (B) is Juice (J); For Sandwich (S), we will select the product that has the highest influence score out of Juice (J) and Banana (B), as Juice (J) and Banana (B) are the only products that influence Sandwich (S), and therefore, the one-arc influence model will be B→S as B→S influence score is 0.6, which is higher then J→S influence score which is 0.5; For Apple (A) we will select the product that has the highest influence score out of Juice (J), Banana (B) and Sandwich (S), as they all affect Apple (A) according to the influence model, and therefore, the one-arc influence model will be S→B as it is associated with the highest influence score: 0.9.

It is to be noted that, with reference to FIG. 4, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Looking at FIG. 5, there is provided a flowchart illustrating one example of a sequence of operations carried out for providing a recommendation relating to a certain entity located at a certain location, in accordance with the presently disclosed subject matter.

According to some examples of the presently disclosed subject matter, system 100 can be configure to perform a recommendation process 300, e.g. utilizing the recommendation module 180.

For that purpose, system 100 can be configured to obtain an influence model, e.g. an influence model generated by the influence models generation process 200 as detailed herein with reference to FIG. 3 (block 310).

System 100 can utilize the influence model for generating a recommendation relating to a selected entity of the entities, located at a given location of the locations, utilizing the influence model (block 320).

It is to be noted that in some cases, the recommendation process 300 can be performed for a plurality of entities at a plurality of locations. In such cases, prior to block 320, the system 100 can optionally be configured to determine a priority according to which the recommendation process 300 will be performed for the various entities at the various locations. Such priority can be determined using multiple parameters, such as: patterns significance, sales lift, supporting evidence, time-based performance measures (such as Cummulative SUM, also known as “CUSUM”), self resolution score, etc. In some cases, a self-resolution score is based on the following metnc:

$$\frac{S ( {t}_{0} )}{S ( {t}_{- 1} )}$$

where S(t₀) are the current sales of the entity at the location, and S(t_{—1}) are the previous time period sales of the entity at the location. The greater such metric score is, the lower the entity will be prioritized.

It is to be noted that in some cases, the influence model utilized for generating the recommendation at block 320 can be an influence model created by the influence models generation process 200 for a certain retailer or group of retailers, other than the retailer for which the recommendation is provided. In other cases, the influence model utilized for generating the recommendation at block 320 can be an influence model created by the influence models generation process 200 for the retailer for which the recommendation is provided only. In other cases, the influence model utilized for generating the recommendation at block 320 can be an influence model created by the influence models generation process 200 for the retailer for which the recommendation is provided and one or more other retailer.

In some cases, the recommendation can be generated only if no negative effect is expected of implementing the recommendation (the determination of the negative effect is detailed herein with reference to FIG. 8). The system 100 can generate various types of recommendations, including one or more of the following: a recommendation to introduce a certain product to a certain location, a recommendation to remove a certain product from a certain location, a recommendation to check why a certain product behaves in an unexpected manner at a certain location (e.g. better or worse than an average behavior of the product at other locations), a recommendation to reposition a certain product, or reposition a certain product in vicinity to one or more other products at the given location, a recommendation to change a pricing of the product at a certain location, a recommendation to change a packaging of the product at a certain location, a recommendation to check the inventory of the product at a given location, a recommendation to perform a promotion of the product at a certain location, etc. A more detailed explanation about the recommendation generation process is provided herein with reference to FIG. 6.

In some cases, system 100 can be further configured to monitor implementation of the recommendation, e.g. utilizing the recommendation implementation monitoring module 190 (block 330). For example, the system 100 can receive manual inputs indicative of implementation of the recommendations, e.g. from a person in charge of the given location (e.g. a store manager), e.g. utilizing an application installed on a computerized device (e.g. a desktop computer, a mobile device such as a smartphone, a tablet computer, etc.). In some cases, the monitoring can alternatively or additionally be automatic. For this purpose, system 100 can be configured to monitor changes in the sale level of the product (data of which can be received by the system 100 in a similar manner to the data obtained at block 210) at the locations and check if the changes indicate that the recommendation was implemented. For example, if the recommendation was to remove a product from a certain location, system 100 can be configured to check that the sales of the product at the certain location stopped. If the recommendation is to insert a product to a certain location, system 100 can be configured to check that sales of the product started and/or that the sales of the product at the location reached a level above the median or average sales level of the product in a group of one or more other locations.

It is to be noted that in some cases, the results of the monitoring can be utilized for making various adjustments to the system 100 for improving its operation. Some examples for such adjustments include changing the influence scores, etc.

In some cases, the system 100 can enable a user, utilizing an application installed on a computerized device (e.g. a desktop computer, a mobile device such as a smartphone, a tablet computer, etc.), to provide a reason to explain low sales of the entity at the location, due to which the recommendation was provided. The user can be, for example, a person in charge of the given location (e.g. a store manager). For this purpose, the system 100 can provide the user with a set of questions for guiding the user during the reasoning process.

In some cases, the user can be first asked if the entity (e.g. a certain product) is available in the location (e.g. if the product is available on one or more shelfs on which it is supposed to be placed in the location). If it is not available, the reason for the low sales is likely a result of availability problems, and in such case, the user can be required to select one of the following exemplary reasons: (a) the entity (e.g. product) is not placed in the correct position (e.g. shelf) in the location; (b) the entity is not placed in any position (e.g. shelf) in the location (e.g. it is in a back room/storage room and not displayed to the potential buyers); (c) the supplier/distribution center is out of stock and therefore the entity is unavailable; (d) the entity has been ordered and is in transite; (e) the entity has just been ordered and should be shipped to the location; (f) the entity cannot be ordered, e.g. due to a system block; (g) the entity soon becomes unavailable (end of life); (h) other reason (the user can provide text including any other reason).

If the entity is available, the system 100 can check (e.g. by asking the user) if the entity (e.g. product) is on promotion. If it is not on promotion, the user can be required to select one of the following exemplary reasons for low sales: (a) the entity's price tag is incorrect; (b) the entity is hidden/not visible or there is a lighting problem; (c) the entity's display is defective; (d) there aren't enough units of the entity; (e) the item recently had availability problems; (e) there is a planogram mismatch; (f) no reason found; (g) known reasoning—no need to check; (h) other reason (the user can provide text including any other reason).

If the entity is on promotion, the user can be required to select one of the following exemplary reasons for low sales: (a) the entity's price tag is incorrect (e.g. not reflecting the promotion price); (b) a promotion label/stand is missing; (c) the entity's positioning does not match guidelines provided for the promotion; (d) the entity is hidden/not visible or there is a lighting problem; (c) the entity's display is defective; (d) there aren't enough units of the entity; (e) the item recently had availability problems; (e) there is a planogram mismatch; (f) no reason found; (g) known reasoning—no need to check; (h) other reason (the user can provide text including any other reason).

In some cases, when the system 100 identifies that the selected reason did not lead to issue resolution (e.g., the user selected “No issue found”, “Known issue”, “Other reason”), the system 100 asks the user to provide additional feedback (e.g. text, one or more images of the entity and/or location, voice recording of the user's explanation, etc.) that will allow the system 100 to improve it's accuracy or assist the user to identify the actual reason the product was underperforming.

The selected reasons can be stored on data repository 130, and the system 100 can utilize the collected reasons information for determining and providing certain high level insights derived from the users' feedbacks. Such insights can be used by the users of the system 100 (such as chain stores management (regional managers and HQ)). This data can be analyzed by different machine learning algorithms based on different parameters and Key Performance Indicators, such as different location (e.g. store) and entity (e.g. product) hierarchy levels. These insights include, for example, the ability to understand in which geographical zones and for which entities (e.g. products) categories there are reports of Out of Stock issues, wrong/missing promotions labels and more.

It is to be noted that, with reference to FIG. 5, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Having described the recommendation process in general, attention is now drawn to FIG. 6, showing a flowchart illustrating one example of a sequence of operations carried out for determining recommendations, in accordance with the presently disclosed subject matter.

According to some examples of the presently disclosed subject matter, system 100 can be configure to perform a recommendation determination process 400, e.g. utilizing the recommendation module 180. In some cases the recommendation determination process 400 detailed herein can be performed for each product at each location. In other cases the recommendation determination process 400 can be performed in a selective manner (e.g. for a specific product at each location, for each product at a specific location, or for a sub group of one or more products of all available products at a subgroup of one or more locations of all available locations).

Turning to the recommendation determination process 400, system 100 can be configured to obtain an indication of a given product and a given location for which a recommendation determination is to be performed (block 405).

System 100 can be configured to check if the given product is currently being sold at the given location (block 410). If so, the system 100 can be configured to check, utilizing the product-related parameters of the given product at the given location, if the given product at the given location is expected to, but does not, yield a high sales level relative to a comparison sales level (block 415). The comparison sales level can be determined utilizing sales-related parameters (being one of the product-related parameters such as a number of sold amounts) of the given product at locations not included in a group of locations that is determined by the system 100 utilizing the influence model comprising the given product. The group of locations can be determined so that for at least one other product, other than the given product, the product-related parameter (e.g. the product sales level) is within a boundary (e.g. higher then a low threshold and lower then a high threshold) in each location of the group. In some cases the boundary can be pre-determined (e.g by the operator of the system) and in some cases it can be dynamically calculated (e.g. as an average/minimal/maximal/etc. sales level of a certain amount/percentage of locations, etc.). The comparison sales level can be an average/minimal/maximal/etc. sales level of the sales levels of the given product at locations not included in the group of locations that is determined by the system).

if the given product at the given location is expected to, but does not, yield a high sales level relative to the comparison sales level, system can be configured to provide a recommendation to check a negative behavior of the selected product at the given location (block 420).

If the given product at the given location does yield a high sales level relative to the comparison sales level, as expected, or following issuance of the recommendation of block 420, system 100 can be further configured to check, utilizing the product-related parameters of the given product at the given location, if the given product at the given location is expected to, but does not, yield a low sales level relative to a comparison sales level (determined for example as detailed herein with reference to block 415) (block 425). If so—the system 100 can be configured to provide a recommendation to check a positive behavior of the selected product at the given location (block 430). It can be appreciated that when a certain product is sold better than expected at a certain location, it may be desirable to understand the reasons for such positive behavior for potentially increasing the sales of such certain product at other locations as well.

If the given product at the given location does yield a low sales level relative to the comparison sales level, as expected, or following issuance of the recommendation of block 430, system 100 can be further configured to check if a sales-related parameter (being one of the product-related parameters such as a number of sold amounts of the given product at the given location) of the given product at the given location is lower than a minimal expected sales-related parameter value (block 440). The minimal expected sales-related parameter value can be determined utilizing sales levels of the given product at locations included in a group of locations that is determined by the system 100 utilizing the influence model comprising the given product. The group of locations can be determined so that for at least one other product, other than the given product, the product-related parameter (e.g. the product sales level) is within a boundary (e.g. higher then a low threshold and lower then a high threshold) in each location of the group. In some cases the boundary can be pre-determined (e.g by the operator of the system) and in some cases it can be dynamically calculated (e.g. as a median/average/minimal/maximal/etc. sales level of a certain amount/percentage of locations, etc.). The minimal expected sales-related parameter value can be for example a minimal sales level or an average sales level calculated utilizing the sales-related parameters of the product-related parameters of the given product at locations included in the group of locations that is determined by the system.

If the sales-related parameter of the given product at the given location is lower than the minimal expected sales-related parameter value, system 100 can be configured to recommend removal of the given product from the given location (block 445).

If the sales-related parameter of the given product at the given location is not lower than the minimal expected sales-related parameter value, or following issuance of the recommendation of block 445, system 100 can be further configured to check if a combined sales level of the given product and a second product, when placed within a certain vicinity within the given location, is expected to be higher than a comparison combined sales level (block 450). The comparison combined sales level can be determined utilizing a combined sales-related parameter (being one of the product-related parameters such as a number of sold amounts) of the given product and the second product at locations not included in a group of locations that is determined by the system 100 utilizing (1) the influence model comprising the given product and the second product, and (2) a products map of the products within the corresponding locations (or any other information that can be used to determine the distance between the products). The group of locations can be determined so that for the target group, the given product and the second product are not located within the certain vicinity, and for the reference group, the given product and the second product are located within the certain vicinity. The comparison sales-related parameter can be an average/minimal/maximal/etc. combined sales level of the sales levels of the given product and the second product at locations not included in the group of locations that is determined by the system.

If a combined sales level of the given product and a second product, when placed within a certain vicinity within the given location, is expected to be higher than a comparison combined sales level, system 100 can be configured to provide a recommendation to move the given product and/or the second product so that they will be placed within the certain vicinity (that can be determined, for example, utilizing the product maps of the locations included in the group) from one another (block 455). It is to be noted that when a reference is made to a vicinity, it may be a metric of distance (e.g. a metric distance), or any indication of the proximity of the products (e.g. in the same aisle, on the same shelf, etc.)

If the combined sales level of the given product and a second product, when placed at a certain vicinity within the given location, is not expected to be higher than a comparison combined sales level or following issuance of the recommendation of block 455, system 100 can be further configured to check, utilizing the influence model, if removing the given product from the given location is expected to result in an increase of sales of at least one second product at the given location, that in turn is expected to result in increased profits at the given location (block 460). For example, assuming that according to the model, when product A is not sold, then product B yields higher sales, then recommend on removing product A.

If so—system 100 can be configured to provide a recommendation to remove the given product from the given location (block 465). If not, or following issuance of the recommendation of block 465, system 100 can optionally be configured to check if any other recommendations, whose implementation is expected to increase the profits in the given location, can be provided (block 470). For example, utilizing information of pricing and/or placement and/or packaging and/or inventory amounts, etc. of the given product at the given location, and the pricing and/or placement and/or packaging and/or inventory amounts of the given product at other locations, the system can determine that it is recommended to change the pricing and/or placement and/or packaging and/or inventory amounts of the given product at the given location.

If any such other recommendation exists, system 100 can be configured to provide it and the process ends (block 475). If not—the process ends (block 480).

In some cases, the other recommendation is to inspect a significant timely change in the sales of the selected product in the given location of the locations, in comparison to the sales of the other locations.

Returning to block 410, if the given product is not sold at the given location, system 100 can be configured to check if introducing the given product to the given location is expected to yield a higher sales level of the given product, or of one or more other products (other then the given product), in the given location than in other locations not included in a group of locations determined utilizing the influence model, and if so—to recommend inserting the given product to the given location (and optionally also indicate an amount, such as a number of units, of the given product to insert to the given location) and the process ends (block 485). The group of locations can be determined so that for at least one other product, other than the given product, the product-related parameter (e.g. the product sales level) is within a boundary (e.g. higher then a low threshold and lower then a high threshold) in each location of the group. In some cases the boundary can be pre-determined (e.g by the operator of the system) and in some cases it can be dynamically calculated (e.g. as an average/minimal/maximal/etc. sales level of a certain amount/percentage of locations, etc.). The comparison sales level can be an average/minimal/maximal/etc. sales level of the sales levels of the given product at locations not included in the group of locations that is determined by the system).

Looking at a simplified example, assuming that a certain product “A” has the following general sales probability P(A=high)=40% (i.e. the probability that A sells at high level, irrespective of any other product, is 40%), P(A=medium)=50% (i.e. the probability that A sells at a medium level, irrespective of any other product, is 50%), P(A=low)=10% (i.e. the probability that A sells at a low level, irrespective of any other product, is 10%), however given the behavior of A depending on B, A has the following sales probabilities: P(A=high|B is sold)=95% (i.e. the probability that A sells at a high level if B is sold at the same location is 95%), P(A=medium|B is sold)=5% (i.e. the probability that A sells at a medium level if B is sold at the same location is 5%), P(A=low|B is sold)=0% (i.e. the probability that A sells at a low level if B is sold at the same location is 0%). In this case, for any location at which product B is sold, but product A is not, introducing product A to the location will yield a high sales level with a probability of 95%, i.e. 55% higher than the sales probability of product A without considering the knowledge of the sales of product B.

In some cases, the recommendations can be more specific. For example, a recommendation to check a positive/negative behavior of a product can be translated (e.g. according to various rules) to one or more of the following more specific action items: check the product's visibility (check if the product is visible to the customers visiting the store), check the products availability (check if the product is available in the store for its customer), increase order quantity of the product, increase order frequency of the product, make an order of the product, change a price of the product at the store, change a location of the product at the store, change a promotion of the product at the store, etc. An example of translating the recommendations to more specific action items is provided herein, inter alia with reference to FIG. 9. In some cases the recommendation (and any other recommendation described herein with reference to FIG. 5) can be provided to one or more person in charge of the given location (e.g. a store manager), e.g. utilizing an application installed on a computerized device (e.g. a desktop computer, a mobile device such as a smartphone, a tablet computer, etc.).

It is to be noted that, with reference to FIG. 6, some of the blocks can be integrated into a consolidated block or can be broken down to a few blocks and/or other blocks may be added. Furthermore, in some cases, the blocks can be performed in a different order than described herein (for example, blocks 425 and 430 can be performed before blocks 415 and 420, etc.). It is to be further noted that some of the blocks are optional. It should be also noted that whilst the flow diagram is described also with reference to the system elements that realizes them, this is by no means binding, and the blocks can be performed by elements other than those described herein.

Attention is now drawn to FIG. 7, a flowchart illustrating one example of a sequence of operations carried out for determining a product time window, in accordance with the presently disclosed subject matter.

According to some examples of the presently disclosed subject matter, system 100 can be configure to perform a product time window determination process 500, e.g. utilizing the time window determination module 160. For this purpose, system 100 can be configured to calculate, for each product, for a plurality of time windows of a common length, a percentage of units sold during the corresponding time window, out of the number of sold units of the product during the period covered by all of the time windows (block 505). In some cases the common length can be pre-determined. In a particular example, each time window is one week.

Looking, for exemplary purposes, on a certain product, for which data representing eight weeks of sales exists, and assuming a common period of one week for each time window, the following values can be calculated:

| Week | W 1 | W 2 | W 3 | W 4 | W 5 | W 6 | W 7 | W 8 |
|---|---|---|---|---|---|---|---|---|
| Units sold | 10 | 40 | 25 | 55 | 45 | 12 | 30 | 10 |
| % of total sold | 4.41% | 17.62% | 11.01% | 24.23% | 19.82% | 5.29% | 13.22% | 4.41% |

Looking for example at week W1, it can be appreciated that 10 units were sold during W1, out of a total of 227 (10+40+25+55+45+12+30+10) units sold during the period of eight weeks (W1-W8) represented in the table, i.e. ˜4.41% of the total sales. In a similar manner, looking at week W4, it can be appreciated that 55 units were sold during W4, out of a total of 227, i.e. ˜24.23% of the total sales.

System 100 can be further configured to find a number of consecutive time windows during which the total percentage of units sold exceeds a threshold (that can be pre-determined) (block 510). Although there can be multiple manners in which this can be performed, a non-limiting example is provided herein, where the threshold is assumed to be set at 50%:

First, the system can find the time period associated with the largest percentage calculated at block 505. In the example provided herein, the week associated with the largest percentage is week W4, that is associated with 24.23% of the total sales:

Step1

| Week | W 1 | W 2 | W 3 | W 4 | W 5 | W 6 | W 7 | W 8 |
|---|---|---|---|---|---|---|---|---|
| Units sold | 10 | 40 | 25 | 55 | 45 | 12 | 30 | 10 |
| % of total sold | 4.41% | 17.62% | 11.01% | 24.23% | 19.82% | 5.29% | 13.22% | 4.41% |

| | |
|---|---|
| Weeks count: | 1 |
| SUM of %: | 24.23% |

The system 100 can be configured to check if the percentage associated with week W4 exceeds the 50% threshold, and if so—return a time window counter that is initially set with the value one (1), which indicates that a single time period amounts for a percentage of the total sales that is above the 50% threshold.

If not (as in the illustrated example as 24.23%<50%)—system 100 can be configured to determine the maximal percentage value of the week before the consecutive week/s that have been processed (i.e. week W3) and the week after the consecutive week/s that have been processed (i.e. week W5). If either the week before or the week after are not included in the data, the system 100 can be configured to utilize a value of zero percent (0%). In the illustrated example, week W5 is associated with the maximal value out of weeks W3 and W5 (as 19.82>11.01). System 100 can be configured to summarize the total percentage of sales during week W4 and week W5, which amounts to 44.05%, and increase the time window count by one:

Step2

| Week | W 1 | W 2 | W 3 | W 4 | W 5 | W 6 | W 7 | W 8 |
|---|---|---|---|---|---|---|---|---|
| Units sold | 10 | 40 | 25 | 55 | 45 | 12 | 30 | 10 |
| % of total sold | 4.41% | 17.62% | 11.01% | [symbol] | 19.82% | 5.29% | 13.22% | 4.41% |

| | |
|---|---|
| Weeks count: | 2 |
| SUM of %: | 44.05% |

The system 100 can be configured to repeat the process until the sum of percentages of the weeks that have been processed (i.e. the weeks whose percentages were summarized) exceeds the threshold. In the illustrated example, week W3 is associated with the maximal value out of weeks W3 and W6 (as 11.01>5.29). System 100 can be configured to summarize the total percentage of sales during weeks W3 to W5, which amounts to 55.07%, and increase the time window count by one. As 55.07% is above the 50% threshold, the number of consecutive time windows during which the total percentage of units sold exceeds the threshold is three (i.e. weeks W3, W4 and W5).

It is to be noted that at the end of block 510, the system 100 has, for each product, an indication of the number of consecutive time periods associated with a percentage of sales above a threshold.

In some cases, the products can be associated with product categories according to the data. In such cases, each product can be associated with a certain category, and each category can include one or more products. For example, various drinks can be associated with a drinks category, various clothes can be associated with a clothing category, various electronic products can be associated with an electronics category, etc. If the products are associated with categories, system can be configured to determine, for each given category, a most frequent number of consecutive time periods out of the numbers of consecutive time periods calculated for each product associated with the given category, and the number of distinct products associated with such most frequent number of consecutive time periods (block 515). Looking at the following example:

| Main Category | Product | Weeks |
|---|---|---|
| Drinks | A | 6 |
| Drinks | B | 10 |
| Drinks | C | 6 |
| Drinks | D | 6 |
| Clothing | E | 2 |
| Clothing | F | 2 |
| Clothing | G | 1 |
| Electronics | H | 6 |
| Electronics | I | 6 |
| Electronics | J | 3 |

It can be appreciated that the most frequent number of consecutive time periods for each category is:

| Main Category | Count (distinct Products) | Weeks |
|---|---|---|
| Drinks | 3 | 6 |
| Clothing | 2 | 2 |
| Electronics | 2 | 6 |

As, for example, in the drinks category, the most frequent number of consecutive time periods is 6 weeks (and the number of distinct products associated with such most frequent number of consecutive time periods is three), in the clothing category the most frequent number of time periods is 2 weeks (and the number of distinct products associated with such most frequent number of consecutive time periods is two), etc.

System 100 can be further configured to determine the product time window as the number of consecutive time windows representing the largest number of distinct products, and if more than one number of consecutive time windows represents the largest number of distinct products—return the maximal number of consecutive time windows of the numbers of consecutive time windows representing the largest number of distinct products (block 520). In the illustrated example, five distinct products are associated with a six weeks consecutive time period, and the system 100 can therefore determine that the product time window is six weeks.

If the products are not associated with product categories, system can be configured to determine the product time window as the most common number of consecutive time periods out of the numbers of consecutive time periods calculated for all products (block 525).

It is to be noted that in some cases the product time window can have a low and/or a high threshold and in such cases, if the calculated product time window calculated in block 520 or block 525 is higher than the high threshold—the product time window will be set according to the high threshold and if the calculated product time window calculated in block 520 or block 525 is lower than the high threshold—the product time window will be set according to the low threshold.

It is to be noted that, with reference to FIG. 7, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Turning to FIG. 8, there is provided a flowchart illustrating one example of a sequence of operations carried out for determining an expected negative effect of implementing a given recommendation, in accordance with the presently disclosed subject matter.

According to some examples of the presently disclosed subject matter, system 100 can be configure to perform a negative effect determination process 600, e.g. utilizing the negative effect determination module 170. For this purpose, system 100 can be configured to determine, for a given recommendation relating to a target product at a target location, a group of supporting locations supporting the recommendation (i.e. locations in which the target product is behaving differently than in the target location (and in some cases in a certain common different manner) (block 610).

System 100 can be further configured to utilize the group of supporting locations for identifying substitutive products of the target product (block 620). Such substitutive products can be products whose behavior at the target location is different than the behavior of the target product and whose behavior at a certain percentage (e.g. a pre-determined percentage, which in a particular example can be 65%) of the group of supporting locations is different than the behavior of the target product. In some cases the behavior is required to be a mirror behavior (e.g. if a product sells at a high sales level at the target location it is required to sell at a low sales level at the group of supporting locations and vice versa. It is to be noted for this purpose that, as detailed herein with reference to FIG. 4, the product-related parameters can be discretisized, for example to low/medium/high sale levels).

In some cases, system 100 can be configured to calculate an average aggregate value of the sales of the target product and the substitutive products (determined at block 620) at the target location (block 630) and an average aggregate value of the sales of the target product and the substitutive products at the group of supporting locations (block 640). System 100 can be configured to check if the average aggregate value of the sales of the target product and the substitutive products at the target location is larger than the average aggregate value of the sales of the target product and the substitutive products at the group of supporting locations (block 650), and if so—determine that no negative effect is expected of implementing the recommendation (block 670). If not—system 100 can determine that a negative effect is expected of implementing the recommendation (block 660).

It is to be noted that, with reference to FIG. 8, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Finally, attention is drawn to FIG. 9, a flowchart illustrating one example of a sequence of operations carried out for merging recommendations generated for two different product definition levels, in accordance with the presently disclosed subject matter.

According to some examples of the presently disclosed subject matter, system 100 can be configure to perform a recommendation merging process 700, e.g. utilizing the recommendation merging module 195. For this purpose, system 100 can be configured to generate recommendations for a first product definition level, utilizing influence models generated for a corresponding product definition level (block 710), and to generate recommendations for a second product definition level, that can be more specific than the first product definition level, utilizing influence models generated for a corresponding more specific product definition level (block 720). In some specific cases, for example when the products are clothes, the first product definition level can be a model and a color of a certain item of clothing (i.e. every available combination of model and color is defined as a product), whereas the second product definition level, that is more specific, can be a specific SKU that can be a model, color and size (i.e. every available model, color and size is defined as a product). Assume for example a certain model A is available is available in the colors black and white, and in sizes small and large, according to the first product definition level, two products exists: A-black and A-white. According to the second product definition level, four products exist: A-black-small, A-black-large, A-white-small and A-white-large. Clearly the second product definition is more specific. It is to be noted that the recommendation generation is performed in accordance with the processes described herein with reference to FIGS. 4-9.

After generating the recommendations for the first product definition level and for the second product definition level, system 100 can be configured to generate recommendations for a first user of the system 100 that can be, for example an operations manager of a group of two or more locations (block 730). In some cases, the recommendations can be generated based on a set of rules, such as the one provided for exemplary purposes in the table below. The table below, and the table provided herein with reference to block 740, includes use of the following parameters (values of which can be obtained for example at block 210):
“SKU inventory in store”—The current inventory level of an SKU at a given location
“Replenishment method”—can be either Manual (inventory is ordered manually) or Machine to Machine (inventory is ordered in an automatic manner, e.g. based on thresholds).
“Inventory Replenishment Limit”—A threshold below which inventory is to be ordered to a location.
“Inventory in DC”—The inventory of a product in a Distribution Center holding inventories of products for supplying to the locations.
“Target sales in units”—The expected sales of a product at a location (e.g. store) during a certain time window.
“Stores in pattern”—a group of supporting locations (e.g. stores) supporting the recommendation (i.e. locations in which the target product is behaving differently than in the target location (and in some cases in a certain common different manner)), as further detailed herein with reference to FIG. 8.
“Segment”—a segment can be, for example, a store type (as in some cases a chain of stores can be divided to sub-groups of stores, each sub-group including stores of a certain common type).

The table describes, for each run type and each replenishment method, a combined recommendation type (for the specific first product definition level that can be model/color, the specific second product definition level that can be SKU, and for the specific replenishment methodrun) and SKUs for which the recommendation can be provided:

| Model- | | | combined | |
|---|---|---|---|---|
| Color | SKU | Replenishment | recommendation | |
| run | run | method | type | SKUs to recommend |
| Insert | — | M2M | Insert | All SKUs of model/color |
| Insert | — | Manual | Insert | All SKUs of model/color |
| Insert | Insert | M2M | Insert | All SKUs of model/color |
| Insert | Insert | Manual | Insert | All SKUs of model/color |
| Insert | Impact | M2M | N/A | N/A |
| Insert | Impact | Manual | N/A | N/A |
| Impact | — | M2M | Impact | If (Model-Color inventory in DC >= “Target |
| | | | | sales in units”) OR (“inventory in DC” is N/A) |
| | | | | then: |
| | | | | List top X (e.g. three) selling SKUs in Model- |
| | | | | Color |
| | | | | Among the top X (e.g. three) selling SKUs: If |
| | | | | SKU inventory in target store =< “inventory |
| | | | | Replenishment Limit” remove SKU from top |
| | | | | X (e.g. three) selling SKUs list. |
| | | | | Among the top X (e.g. three) selling |
| | | | | SKUs: If SKU inventory in target store = 2 |
| | | | | and “inventory Replenishment Limit” = 0 |
| | | | | highlight SKU. |
| | | | | Among the top X (e.g. three) selling SKUs: If |
| | | | | SKU OOS days/max(OOS days in all stores |
| | | | | in segment) > Y (e.g. 0.75) AND OOS days > |
| | | | | Z (e.g. three) highlight SKU. |
| | | | | Else: All SKUs of model/color |
| Impact | — | Manual | Impact | If (Model-Color inventory in DC >= “Target |
| | | | | sales in units”) OR (“inventory in DC” is N/A) |
| | | | | then: |
| | | | | List top X (e.g. three) selling SKUs in Model- |
| | | | | Color |
| | | | | Among the top X (e.g. three) selling SKUs: If |
| | | | | SKU inventory in target store = 2 highlight |
| | | | | SKU. |
| | | | | Among the top X (e.g. three) selling SKUs: If |
| | | | | SKU OOS days/max(OOS days in all stores |
| | | | | in segment) > Y (e.g. 0.75) AND OOS days > |
| | | | | Z (e.g. three) highlight SKU. |
| | | | | Among the top X (e.g. three) selling SKUs: If |
| | | | | SKU inventory in target store = 0 and SKU |
| | | | | sales in store >0 highlight SKU. |
| | | | | Else: All SKUs of model/color |
| Impact | Insert | M2M | Impact | Show the SKU that got the Insert |
| | | | | recommendation and highlight it. |
| | | | | If (Model-Color inventory in DC >= “Target |
| | | | | sales in units”) OR (“inventory in DC” is N/A) |
| | | | | then: |
| | | | | Add: List top X (e.g. three) selling SKUs in |
| | | | | Model-Color. |
| | | | | Among the top X (e.g. three) selling SKUs: If |
| | | | | SKU inventory in target store =< “inventory |
| | | | | Replenishment Limit” remove SKU from top |
| | | | | X (e.g. three) selling SKUs list. |
| | | | | Among the top X (e.g. three) selling SKUs: If |
| | | | | SKU inventory in target store = 2 and |
| | | | | “inventory Replenishment Limit” = 0 highlight |
| | | | | SKU. |
| | | | | Among the top X (e.g. three) selling SKUs: If |
| | | | | SKU OOS days/max(OOS days in all stores |
| | | | | in segment) > Y (e.g. 0.75) AND OOS days > |
| | | | | Z (e.g. three) highlight SKU. |
| Impact | Insert | Manual | Impact | Show the SKU that got the Insert |
| | | | | recommendation and highlight it. |
| | | | | If (Model-Color inventory in DC >= “Target |
| | | | | sales in units”) OR (“inventory in DC” is N/A) |
| | | | | then: |
| | | | | Add: List top X (e.g. three) selling SKUs in |
| | | | | Model-Color. |
| | | | | Among the top X (e.g. three) selling SKUs: If |
| | | | | SKU inventory in target store = 2 highlight |
| | | | | SKU. |
| | | | | Among the top X (e.g. three) selling SKUs: If |
| | | | | SKU OOS days/max(OOS days in all stores |
| | | | | in segment) > Y (e.g. 0.75) AND OOS days > |
| | | | | Z (e.g. three) highlight SKU. |
| | | | | Among the top X (e.g. three) selling SKUs: If |
| | | | | SKU inventory in target store = 0 and SKU |
| | | | | sales in store >0 highlight SKU. |
| Impact | Impact | M2M | Impact | Show the SKU that got the recommendation |
| OR “—” | | | | and highlight it. |
| Impact | Impact | Manual | Impact | Show the SKU that got the recommendation |
| OR “—” | | | | and highlight it. |
| — | Insert | M2M | Insert | If Model-Color sales in store >0 then show |
| | | | | SKU. |
| | | | | Else do not show recommendation. |
| — | Insert | Manual | Insert | If Model-Color sales in store >0 then show |
| | | | | SKU. |
| | | | | Else do not show recommendation. |

In some cases, the system 100 can enable the first user to select which recommendations to provide to one or more second users that can be, for example, location managers (e.g. store managers).

In some cases, system 100 can additionally, or alternatively (to block 730), be configured to generate specific action items to the one or more second users of the system 100, that in some cases can be the location managers (e.g. store managers) (block 740). In some cases, the action items can be determined according to a set of rules, such as the one provided for exemplary purposes in the following table. If the system 100 utilizes the input received from the first user (if such input exists), the table refers to action items relating to those recommendations selected by the first user to be provided to the second users, otherwise, the action items generated at block 740 are not thus limited.

The table describes, for each recommendation type, each run type and each replenishment method, the way Insert and Impact recommendations are translated to one or more action items:

| Model- | | | | | Increase | | |
|---|---|---|---|---|---|---|---|
| Color | SKU | Rep. | | | order size/ | | Introduce to |
| run | run | method | Visibility | Availability | velocity | Order | assortment |
| Insert | — | M2M | — | — | — | — | Generate |
| | | | | | | | introduce to |
| | | | | | | | assortment |
| | | | | | | | action item for |
| | | | | | | | the Model-Color |
| Insert | — | Manual | — | — | — | — | Generate |
| | | | | | | | introduce to |
| | | | | | | | assortment |
| | | | | | | | action item for |
| | | | | | | | the Model-Color |
| Insert | Insert | M2M | — | — | — | — | Generate |
| | | | | | | | introduce to |
| | | | | | | | assortment |
| | | | | | | | action item for |
| | | | | | | | the Model-Color |
| Insert | Insert | Manual | — | — | — | — | Generate |
| | | | | | | | introduce to |
| | | | | | | | assortment |
| | | | | | | | action item for |
| | | | | | | | the Model-Color |
| Insert | Impact | M2M | — | — | — | — | — |
| Insert | Impact | Manual | — | — | — | — | — |
| Impact | — | M2M | If Model-Color | If Model-Color | In top X (e.g. | — | — |
| | | | inventory in DC >= | inventory in DC < | three) selling | | |
| | | | “Target sales in | “Target sales in | SKUs list | | |
| | | | units” OR Model- | units” don't | calculated for | | |
| | | | Color inventory in | generate check | availability: | | |
| | | | store >= “Target | availability action | If Out Of Stock | | |
| | | | sales in units” | item. Else: | (OOS) days/ | | |
| | | | generate check | Generate check | max(OOS days | | |
| | | | visibility action | availability action | in all stores in | | |
| | | | item for | item for top X | segment) > Y | | |
| | | | the Model-Color. | (e.g. three) | (e.g. 0.75) AND | | |
| | | | Else don't | selling SKUs in | OOS days > Z. | | |
| | | | generate check | Model-Color at | (e.g. three) | | |
| | | | visibility action | supporting | generate | | |
| | | | item. | locations | increase order | | |
| | | | | (supporting the | size/frequency | | |
| | | | | recommendation) | for SKU | | |
| | | | | where: | Else don't | | |
| | | | | If SKU inventory | show “Increase | | |
| | | | | level =< | order size/ | | |
| | | | | “inventory | frequency”. | | |
| | | | | Replenishment | | | |
| | | | | Limit” don't | | | |
| | | | | include the | | | |
| | | | | specific SKU | | | |
| | | | | among top X (e.g. | | | |
| | | | | three) selling | | | |
| | | | | SKUs. | | | |
| | | | | If “inventory | | | |
| | | | | Replenishment | | | |
| | | | | Limit” = 0 and | | | |
| | | | | SKU inventory | | | |
| | | | | level = 2 then | | | |
| | | | | include the | | | |
| | | | | specific SKU | | | |
| | | | | among the top X | | | |
| | | | | (e.g. three) | | | |
| | | | | selling SKUs. | | | |
| Impact | — | Manual | If Model-Color | If Model-Color | In top X (e.g. | if Model-Color | — |
| | | | inventory in DC >= | inventory in DC < | three) selling | Inventory in DC < | |
| | | | “Target sales in | “Target sales in | SKUs list | “Target sales | |
| | | | units” OR Model- | units” don't | calculated for | in units” don't | |
| | | | Color inventory in | generate check | availability: | generate order | |
| | | | store >= “Target | availability action | If OOS days/ | action item. | |
| | | | sales in units” | item. Else: | max(OOS days | If Inventory of | |
| | | | generate check | generate check | in all stores in | SKU in top X | |
| | | | visibility action | availability action | segment) > Y | (e.g. three) | |
| | | | item for the | item for top X | (e.g. 0.75) AND | selling SKUs = | |
| | | | Model-Color. | (e.g. three) | OOS days > Z | 0 and SKU | |
| | | | Else don't | selling SKUs in | (e.g. three) | sales in store > | |
| | | | generate check | Model-Color at | generate | 0 generate | |
| | | | visibility action | supporting | increase order | Order action | |
| | | | item. | locations where: | size/frequency | item on SKU. | |
| | | | | If Inventory of | action item for | | |
| | | | | SKU in top X (e.g. | SKU | | |
| | | | | three) selling | Else don't | | |
| | | | | SKUs = 1 then | generate | | |
| | | | | highlight SKU in | increase order | | |
| | | | | the list. | size/frequency | | |
| | | | | | action item. | | |
| Impact | Insert | M2M | If Model-Color | If Model-Color | In top X (e.g. | — | Generate |
| | | | inventory in DC >= | inventory in DC < | three) selling | | introduce to |
| | | | “Target sales in | “Target sales in | SKUs list | | assortment |
| | | | units” OR Model- | units” don't | calculated for | | action item for |
| | | | Color inventory in | generate check | avaliability: | | SKU that got the |
| | | | store >= “Target | availability action | If OOS days/ | | insert |
| | | | sales in units” | item. Else: | max(OOS days | | recommendation |
| | | | generate check | generate check | in all stores in | | |
| | | | visibility action | availability action | segment) > Y | | |
| | | | item for the | item for list of top | (e.g. 0.75) AND | | |
| | | | Model-Color. | X (e.g. three) | OOS days > Z | | |
| | | | Else don't | selling SKUs in | (e.g. three) | | |
| | | | generate check | Model-Color at | generate | | |
| | | | visibility action | stores in pattern | increase order | | |
| | | | item. | where: | size/frequency | | |
| | | | | If SKU Inventory | action item for | | |
| | | | | level =< | SKU and | | |
| | | | | “inventory | highlight the | | |
| | | | | Replenishment | SKU in list | | |
| | | | | Limit” include | Else don't | | |
| | | | | the specific SKU | generate | | |
| | | | | among the top X | increase order | | |
| | | | | (e.g. three) | size/frequency | | |
| | | | | selling SKUs. | action item | | |
| | | | | If “inventory | | | |
| | | | | Replenishment | | | |
| | | | | Limit” = 0 and | | | |
| | | | | SKU Inventory | | | |
| | | | | level = 2 then | | | |
| | | | | highlight the SKU | | | |
| | | | | in the list. | | | |
| Impact | Insert | Manual | If Model-Color | If Model-Color | In top X (e.g. | If Model-Color | Generate |
| | | | inventory in DC >= | inventory in DC < | three) selling | inventory in | introduce to |
| | | | “Target sales in | “Target sales in | SKUs list | DC < “Target | assortment |
| | | | units” OR Model- | units” don't | calculated for | sales in units” | action item for |
| | | | Color inventory in | generate check | availability: | don't generate | SKU that got the |
| | | | store >= “Target | availability action | if OOS days/ | order action | insert |
| | | | sales in units” | item. Else: | max(OOS days | item | recommendation |
| | | | generate check | generate check | in all stores in | If Inventory of | |
| | | | visibility action | availability action | segment) > Y | SKU in top X | |
| | | | item for the | item for list of top | (e.g. 0.75) AND | (e.g. three) | |
| | | | Model-Color. | X (e.g. three) | OOS days > Z | selling SKUs = | |
| | | | Else don't | selling SKUs; in | (e.g. three) | 0 and SKU | |
| | | | generate check | Model-Color at | generate | sales in store > | |
| | | | visibility action | stores in pattern | increase order | 0 generate | |
| | | | item. | where: | size/frequency | Order action | |
| | | | | If Inventory of | action item for | item for SKU. | |
| | | | | SKU in top X (e.g. | SKU and | | |
| | | | | three) selling | highlight SKU | | |
| | | | | SKUs = 1 then | in the list) | | |
| | | | | highlight the SKU | Else don't | | |
| | | | | in the list. | generate | | |
| | | | | | increase order | | |
| | | | | | size/frequency | | |
| | | | | | action item | | |
| | | | | | In top X (e.g. | | |
| | | | | | three) selling | | |
| | | | | | SKUs list | | |
| | | | | | calculated for | | |
| | | | | | availability: | | |
| | | | | | If OOS days/ | | |
| | | | | | max(OOS days | | |
| | | | | | in all stores in | | |
| | | | | | segment) > Y | | |
| | | | | | (e.g. 0.75) AND | | |
| | | | | | OOS days > Z | | |
| | | | | | (e.g. three) | | |
| | | | | | generate | | |
| | | | | | increase order | | |
| | | | | | size/frequency | | |
| | | | | | action item for | | |
| | | | | | SKU and | | |
| | | | | | highlight the | | |
| | | | | | SKU in the iist) | | |
| | | | | | Else don't | | |
| | | | | | generate | | |
| | | | | | increase order | | |
| | | | | | size/frequency | | |
| | | | | | action item | | |
| Impact | Impact | M2M | If SKU inventory | If SKU inventory | In top X (e.g. | — | — |
| or “—” | | | in DC >= “Target | in DC < “Target | three) selling | | |
| | | | sales in units” OR | sales in units” | SKUs list | | |
| | | | SKU inventory in | don't generate | calculated for | | |
| | | | store >= “Target | check availability | availability: | | |
| | | | sales in units” | action item. Else: | if OOS days/ | | |
| | | | generate check | If “inventory | max(OOS days | | |
| | | | visibility action | Replenishment | in all stores in | | |
| | | | item for SKU that | Limit” = 0 and | segment) > Y | | |
| | | | got the | SKU inventory | (e.g. 0.75) AND | | |
| | | | recommendation. | level = 2 then | OOS days > Z | | |
| | | | Else don't | generate check | (e.g. three) | | |
| | | | generate check | availability action | generate | | |
| | | | visibility action | item for SKU | increase order | | |
| | | | item. | level. | size/frequency | | |
| | | | | | action item for | | |
| | | | | | SKU and | | |
| | | | | | highlight the | | |
| | | | | | SKU in the list) | | |
| | | | | | Else don't | | |
| | | | | | generate | | |
| | | | | | increase order | | |
| | | | | | size/frequency | | |
| | | | | | action item | | |
| Impact | Impact | Manual | If SKU inventory | If SKU inventory | In top X (e.g. | If SKU | — |
| or “—” | | | in DC >= “Target | in DC < “Target | three) selling | inventory in DC < | |
| | | | sales in units” OR | sales in units” | SKUs list | “Target sales | |
| | | | SKU inventory in | don't generate | calculated for | in units” don't | |
| | | | store >= “Target | check availability | availability: | generate order | |
| | | | sales in units” | action item. Else: | If OOS days/ | action item. | |
| | | | generate check | If Inventory of | max(OOS days | If Inventory of | |
| | | | visibility action | SKU = 1 then | in all stores in | SKU = 0 and | |
| | | | item for SKU that | generate check | segment) > Y | SKU sales in | |
| | | | got the | availability action | (e.g. 0.75) AND | store > 0 | |
| | | | recommendation. | item for SKU | OOS days > Z | generate order | |
| | | | Else don't | level. | (e.g. three) | action item for | |
| | | | generate check | | generate | SKU. | |
| | | | visibility action | | increase order | | |
| | | | item. | | size/frequency | | |
| | | | | | for SKU and | | |
| | | | | | highlight the | | |
| | | | | | SKU in the list | | |
| | | | | | Else don't | | |
| | | | | | generate | | |
| | | | | | increase order | | |
| | | | | | size/frequency | | |
| | | | | | action item. | | |
| — | Insert | M2M | — | — | — | — | If Model-Color |
| | | | | | | | sales in store > 0 |
| | | | | | | | Generate |
| | | | | | | | introduce to |
| | | | | | | | assortment |
| | | | | | | | action item for |
| | | | | | | | SKU level |
| — | Insert | Manual | — | — | — | — | If Model-Color |
| | | | | | | | sales in store > 0 |
| | | | | | | | Generate |
| | | | | | | | introduce to |
| | | | | | | | assortment |
| | | | | | | | action item for |
| | | | | | | | SKU level |

It is to be noted that, with reference to FIG. 9, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

Attention is drawn to FIG. 10, showing a flowchart illustrating one example of a sequence of operations carried out for cross validating recommendations, in accordance with the presently disclosed subject matter.

According to some examples of the presently disclosed subject matter, system 100 can be configure to perform a recommendation cross validation process 800, e.g. utilizing the time recommendation module 180. For this purpose, system 100 can be configured to generate a plurality of recommendation sets, each based on a different influence model (block 810). The recommendation sets can be generated by executing the recommendation process 300 detailed above, inter alia with respect to FIG. 5. The different influence models can be generated by executing the influence models generation process 200 detailed above, inter alia with respect to FIG. 4. It is to be noted that the system 100 can generate a plurality of different influence models for example by selecting the locations that participate in the influence models generation process 200, or by changing the influence score calculation method (e.g. using another formula for calculating the influence scores), or by changing the pruning rules, or by changing discretization of the product-related parameter, or by any other method.

System 100 can be further configured to filter the recommendations generated at block 810 for removing recommendations that do not meet one or more thresholds (block 820). The thresholds can be based, for example, on: expected revenues from implementing the recommendation (e.g. if implementing the recommendation is expected to generate over a certain amount of money); expected number of unit sales from implementing the recommendation (e.g. if implementing the recommendation is expected to generate over a certain number of units sold); a minimal probability of success if the recommendation is implemented; a certain lift in sales (e.g. the number of units expected to be sold divided by the number of units currently sold is higher than a threshold); a minimal number of locations supporting the recommendations (if the recommendation is supported by a certain number of locations, higher than a certain threshold); etc.

System can also be configured to deduplicate duplicate recommendations (block 830). Duplicate recommendations are recommendations relating to the same entity at the same location. In some cases, an identical recommendation can be generated using two different influence models, and in such cases, the system 100 can be configured to keep only one of the duplicate recommendations, having a higher priority score. The priority score can be determined using one or more of the following parameters: expected revenues from implementing the recommendation (e.g. the higher the expected revenues are—the higher the priority score is); expected number of unit sales from implementing the recommendation (the higher the number of units expected to be sold—the higher the priority score is); a minimal probability of success if the recommendation is implemented; a certain lift in sales (the higher the priority of success if implementing the recommendation—the higher the priority score is); a minimal number of locations supporting the recommendations (the higher the number of locations supporting the recommendations—the higher the priority score is); etc.

System can be further configured to check if the remaining recommendations meet pre-defined criteria (block 840). In some cases, the pre-defined criteria can be based on expected sales (or a derivative thereof) if the recommendations are implemented. In addition, or as an alternative, the pre-defined criteria can be based on a number of locations associated with one or more of the remaining recommendations. In a particular example, the pre-defined criteria can be that the expected revenue—expected if the remaining recommendations are implemented—is higher than a certain threshold, and that the number of locations that are associated with one or more of the remaining recommendations is higher than a certain threshold.

If the remaining recommendations meet the pre-defined criteria—the process ends (block 850). If not—system 100 can be configured to generate a plurality of new recommendation sets (e.g. utilizing the recommendation process 300), each based on a new and different influence model (block 860), and the process can continue at block 820. The new and different influence model can be generated utilizing the influence models generation process 200, as detailed above while changing the parameters for the influence models generation process 200 (e.g. selecting different locations that participate in the influence models generation process 200, changing the influence score calculation method, changing the pruning rules, changing discretization of the product-related parameter, etc.).

It is to be noted that, with reference to FIG. 9, some of the blocks can be integrated into a consolidated block or can be broken down to a few blocks and/or other blocks may be added. It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for data analysis, the system comprising a processor configured to:
obtain data relating to a plurality of entities associated with a plurality of distinct locations, the data including a plurality of values of one or more entity-related parameters related to each entity of the entities at each location of the locations, each value representing a corresponding time period;
calculate, for a plurality of entity pairs of the entities, utilizing the values, an influence score indicative of a connection between at least one of the entity-related parameters of the entity pair at the plurality of locations; and
generate, utilizing the influence scores, one or more influence models, each describing influences between two or more of the entities and being usable for generating recommendations relating to at least one entity of the entities, wherein the influences are single-sided so that for each given entity of the entities and any other entity of the entities that is directly or indirectly influenced by the given entity according to the corresponding model, the given entity is not influenced by the other entity according to the corresponding influence model.

2. The system of claim 1 wherein each of the influence models is a simple weighted directed graph comprising a plurality of nodes, wherein each node of the nodes is associated with a distinct entity of the entities and each connection connecting a pair of the nodes is associated with a weight, the weight being associated with the influence score of the corresponding entities.

3. The system of claim 2 wherein the influence models are generated such that for each influence model of the influence models, a function of the weights associated with the influence model's connections exceeds a threshold.

4. (canceled)

5. (canceled)

6. The system of claim 1 wherein the entities are products and the entity-related parameters are product-related parameters including at least one of the following:
a. a number of sold amounts of the product;
b. a revenue generated from sale of the number of sold amounts of the product;
c. a profit generated from sale of the number of sold amounts of the product;
d. a number of stored amounts of the product;
e. a number of ordered amounts of the product;
f. a cost of purchase of the number of sold amounts of the product;
g. a forecasted sales amount;
h. a forecasted revenue from the forecasted sales amount;
i. a forecasted profit from the forecasted sales amount;
j. a forecasted number of stored amounts of the product;
k. a forecasted number of ordered amounts of the product; or
l. an interest indicative parameter.

7. (canceled)

8. The system of claim 1, wherein the entities are products and wherein the processor is further configured to provide a recommendation relating to a selected product of the products, at a given location of the locations, utilizing the influence model.

9. The system of claim 8, wherein the recommendation is one of the following:
(a) to introduce the selected product to the given location, the given location belonging to a group of two or more selected locations of the locations, wherein the selected product is not located at the given location and wherein introducing the selected product to the given location is expected to yield a high sales level of the selected product at the given location relative to locations that are not included in the group, wherein the group is determined utilizing the influence model;
(b) to check behavior of the selected product at the given location, the given location belonging to a group of two or more selected locations of the locations, wherein the selected product is located at the given location according to the data and wherein the given product at the given location is expected to, but does not, yield a high sales level relative to locations not included in the group, wherein the group is determined utilizing the influence model; and
(c) to check behavior of the selected product at the given location, the given location belonging to a group of two or more selected locations of the locations, wherein the selected product is located at the given location according to the data and wherein the given product at the given location is expected to, but does not, yield a low sales level relative to locations not included in the group, wherein the group is determined utilizing the influence model.

10. (canceled)

11. (canceled)

12. The system of claim 8, wherein the recommendation is to remove the selected product from the given location, wherein the selected product is located at the given location according to the data and wherein a sales-related parameter of the product-related parameters of the selected product at the given location is lower than a minimal expected sales-related parameter calculated utilizing sales-related parameters of the selected product at a group of two or more selected locations of the locations, wherein the group is determined utilizing the influence model.

13. The system of claim 8, wherein the recommendation is one of the following:
(A) to move the selected product, located at the given location, the given location belonging to a group of two or more selected locations of the locations, to a certain vicinity to a second product of the products located at the given location, wherein the selected product and the second product are located at the given location according to the data and wherein a combined sales level of the selected product and the second product is expected to be higher than a combined sales level of the selected product and the second product at locations that are not included in the group, wherein the group is determined utilizing (a) the influence model and (b) a products map of the products within the corresponding locations; and
(B) to introduce the selected product to the given location, the given location belonging to a group of two or more selected locations of the locations, wherein the selected product is not located at the given location and wherein introducing the selected product to the given location is expected to yield a high sales level of at least one other product at the given location relative to locations that are not included in the group, wherein the group is determined utilizing the influence model.

14. (canceled)

15. (canceled)

16. (canceled)

17. (canceled)

18. (canceled)

19. The system of claim 8, wherein the recommendation is to remove the selected product from the given location, wherein the selected product is located at the given location according to the data and wherein removing the selected product from the given location is expected to result in an increase of the sales of at least one second product at the given location wherein the increase of the sales of the second product results in increased profits at the given location.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A method for data analysis, the method comprising:
obtaining data relating to a plurality of entities associated with a plurality of distinct locations, the data including a plurality of values of one or more entity-related parameters related to each entity of the entities at each location of the locations, each value representing a corresponding time period;
calculating, by a processor, for a plurality of entity pairs of the entities, utilizing the values, an influence score indicative of a connection between at least one of the entity-related parameters of the entity pair at the plurality of locations; and
generating, by the processor, utilizing the influence scores, one or more influence models, each describing influences between two or more of the entities and being usable for generating recommendations relating to at least one entity of the entities, wherein the influences are single-sided so that for each given entity of the entities and any other entity of the entities that is directly or indirectly influenced by the given entity according to the corresponding model, the given entity is not influenced by the other entity according to the corresponding influence model.

36. The method of claim 35 wherein each of the influence models is a simple weighted directed graph comprising a plurality of nodes, wherein each node of the nodes is associated with a distinct entity of the entities and each connection connecting a pair of the nodes is associated with a weight, the weight being associated with the influence score of the corresponding entities.

37. The method of claim 36 wherein the influence models are generated such that for each influence model of the influence models, a function of the weights associated with the influence model's connections exceeds a threshold.

38. (canceled)

39. (canceled)

40. The method of claim 35 wherein the entities are products and the entity-related parameters are product-related parameters including at least one of the following:
a. a number of sold amounts of the product;
b. a revenue generated from sale of the number of sold amounts of the product;
c. a profit generated from sale of the number of sold amounts of the product;
d. a number of stored amounts of the product;
e. a number of ordered amounts of the product;
f. a cost of purchase of the number of sold amounts of the product;
g. a forecasted sales amount;
h. a forecasted revenue from the forecasted sales amount;
i. a forecasted profit from the forecasted sales amount;
j. a forecasted number of stored amounts of the product;
k. a forecasted number of ordered amounts of the product; or
l. an interest indicative parameter.

41. (canceled)

42. The method of claim 35, wherein the entities are products and wherein the method further comprises providing a recommendation relating to a selected product of the products, at a given location of the locations, utilizing the influence model.

43. The method of claim 42, wherein the recommendation is one of the following:
(a) to introduce the selected product to the given location, the given location belonging to a group of two or more selected locations of the locations, wherein the selected product is not located at the given location and wherein introducing the selected product to the given location is expected to yield a high sales level of the selected product at the given location relative to locations that are not included in the group, wherein the group is determined utilizing the influence model;
(b) to check behavior of the selected product at the given location, the given location belonging to a group of two or more selected locations of the locations, wherein the selected product is located at the given location according to the data and wherein the given product at the given location is expected to, but does not, yield a high sales level relative to locations not included in the group, wherein the group is determined utilizing the influence model; and
(c) to check behavior of the selected product at the given location, the given location belonging to a group of two or more selected locations of the locations, wherein the selected product is located at the given location according to the data and wherein the given product at the given location is expected to, but does not, yield a low sales level relative to locations not included in the group, wherein the group is determined utilizing the influence model.

44. (canceled)

45. (canceled)

46. The method of claim 42, wherein the recommendation is to remove the selected product from the given location, wherein the selected product is located at the given location according to the data and wherein a sales-related parameter of the product-related parameters of the selected product at the given location is lower than a minimal expected sales-related parameter calculated utilizing sales-related parameters of the selected product at a group of two or more selected locations of the locations, wherein the group is determined utilizing the influence model.

47. The method of claim 42, wherein the recommendation is one of the following:
(A) to move the selected product, located at the given location, the given location belonging to a group of two or more selected locations of the locations, to a certain vicinity to a second product of the products located at the given location, wherein the selected product and the second product are located at the given location according to the data and wherein a combined sales level of the selected product and the second product is expected to be higher than a combined sales level of the selected product and the second product at locations that are not included in the group, wherein the group is determined utilizing (a) the influence model and (b) a products map of the products within the corresponding locations; and
(B) to introduce the selected product to the given location, the given location belonging to a group of two or more selected locations of the locations, wherein the selected product is not located at the given location and wherein introducing the selected product to the given location is expected to yield a high sales level of at least one other product at the given location relative to locations that are not included in the group, wherein the group is determined utilizing the influence model.

48. (canceled)

49. (canceled)

50. (canceled)

51. (canceled)

52. (canceled)

53. The method of claim 42, wherein the recommendation is to remove the selected product from the given location, wherein the selected product is located at the given location according to the data and wherein removing the selected product from the given location is expected to result in an increase of the sales of at least one second product at the given location wherein the increase of the sales of the second product results in increased profits at the given location.

54. The method of claim 42, wherein the recommendation is to change a pricing or a placement or a packaging or a number of stored amounts of the selected product, or to perform a promotion of the selected product, in the given location of the locations, wherein the selected product is located at the given location according to the data and wherein acting upon the recommendation is expected to increase profits at the at the given location.

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. A non-transitory computer readable storage medium having computer readable program code embodied therewith, the computer readable program code, executable by at least one processor of a computer to perform a method comprising:
obtaining data relating to a plurality of entities associated with a plurality of distinct locations, the data including a plurality of values of one or more entity-related parameters related to each entity of the entities at each location of the locations, each value representing a corresponding time period;
calculating, by a processor, for a plurality of entity pairs of the entities, utilizing the values, an influence score indicative of a connection between at least one of the entity-related parameters of the entity pair at the plurality of locations; and
generating, by the processor, utilizing the influence scores, one or more influence models, each describing influences between two or more of the entities and being usable for generating recommendations relating to at least one entity of the entities, wherein the influences are single-sided so that for each given entity of the entities and any other entity of the entities that is directly or indirectly influenced by the given entity according to the corresponding model, the given entity is not influenced by the other entity according to the corresponding influence model.
